(19) United States
(12) Patent Application Publication
(10) Pub. No.: US 2026/0307591 A1
(43) Pub. Date: Oct. 8, 2026

(54) HITCH CONNECTION DEVICE

(71) Applicant: Thule Sweden AB, Hillerstorp (SE)

(72) Inventors: Johan BOLMSTAM, Värnamo (SE); Petter KARLSSON, Huskvarna (SE); Fredrik LARSSON, Vaggeryd (SE); Philip HAMNGREN, Grimsås (SE); Jonatan HÖRDER, Vaggeryd (SE); Jimmy HJULFORS, Jönköping (SE); Samuel ATTING THORIN, Jönköping (SE)

(21) Appl. No.: 19/633,331

(22) Filed: Mar. 30, 2026

Related U.S. Application Data
(60) Provisional application No. 63/783,624, filed on Apr. 4, 2025.

(51) Int. Cl. B60R 9/06; B60R 9/10

(52) U.S. Cl. CPC B60R 9/06; B60R 9/10

(57) ABSTRACT

A hitch-mounted load carrier includes a connecting member and a locking mechanism. The connecting member is configured to be inserted into a hitch receiver. The locking mechanism couples to the connecting member and is configured to secure the connecting member inside the hitch receiver. The locking mechanism includes a first actuator, and second actuator, a shaft, and a clamp assembly. The first actuator is disposed in an interior of the connecting member. The second actuator is opposite the first actuator and disposed in the interior of the connecting member. The shaft is configured to move the first actuator and the second actuator. The clamp assembly includes a first contact member and a second contact member. The first and second contact members are configured to engage an interior surface of the hitch receiver.

### CROSS REFERENCE TO RELATED APPLICATIONS

This application claim priority to U.S. Provisional Application No. 63/783,624, filed Apr. 4, 2025. This application is hereby incorporated herein in its entirety by reference.

### BACKGROUND

### Field

The present disclosure relates to hitch attachment devices. More specifically, embodiments of the present disclosure relate to hitch-mounted load carriers, for example, bicycle carriers, with a locking mechanism to secure the load carrier to a vehicle hitch.

### Background

Devices for carrying equipment on a vehicle can be used to transport the equipment from one place to another. In some examples, the load carrier can be secured to the vehicle safely and conveniently via a hitch, typically attached to the rear of the vehicle. Various attachment mechanisms, for example, wedges, can help secure the load carrier to the vehicle hitch. These mechanisms, however, can lose torque over time, deemed torque-loss, or may damage or deform the interior of the hitch over time, causing the mechanism to be frequently manually re-secured by the user.

Safely transporting sports equipment is a concern for many sports enthusiasts. If a bicycle rack, for example, were to become disconnected from a vehicle while driving it could damage the rack and bicycles being transported and affect the safety of other motorists. One way to secure a rack to a vehicle is to insert a pin through holes in both the hitch receiver and the connecting member of the load carrier. Depending on the strength of the person attaching the rack, the weight of the rack, and other environmental conditions, it can be difficult to secure the rack with the pin. Various embodiments disclosed herein enable a pin to easily and securely attach a rack to a hitch.

### BRIEF SUMMARY

Accordingly, there is a need to provide a locking mechanism that can securely couple a load carrier to a hitch of a vehicle and maintain torque between the locking mechanism and the hitch receiver, and a securement pin that can repeatably locate in pin holes of a hitch receiver.

In some embodiments, a hitch-mounted load carrier includes a connecting member and a locking mechanism. In some embodiments, the connecting member is configured to be inserted into a hitch receiver. In some embodiments, the locking mechanism couples to the connecting member and is configured to secure the connecting member inside the hitch receiver. In some embodiments, the locking mechanism includes a first actuator, a second actuator, a shaft, and a clamp assembly. In some embodiments, the first actuator is disposed in an interior of the connecting member. In some embodiments, the second actuator is opposite the first actuator and disposed in the interior of the connecting member. In some embodiments, the shaft is configured to move at least one of the first actuator and the second actuator. In some embodiments, the clamp assembly includes a first contact member and a second contact member. In some embodiments, the first and second contact members are configured to engage an interior surface of the hitch receiver.

In some embodiments, a first surface of the clamp assembly contacts the first actuator and a second surface of the clamp assembly contacts the second actuator. In some embodiments, the first and second actuators are configured to translate the clamp assembly. In some embodiments, at least one of the first surface and the second surface includes an arc-shape.

In some embodiments, the clamp assembly includes a first clamp and a second clamp. In some embodiments, the first clamp moves independently of the second clamp in a first direction. In some embodiments, one of the first clamp or the second clamp includes a protrusion, and the other of the first clamp and the second clamp includes a recess configured to receive the protrusion. In some embodiments, when the protrusion engages the recess, the first clamp and second clamp move together.

In some embodiments, the first clamp includes a first side wall and the second clamp includes a second side wall configured to engage the first side wall and transfer a load from the second clamp to the first clamp or receive a load from the first clamp. In some embodiments, the clamp assembly includes a bridge connecting the first and second contact members.

In some embodiments, the locking mechanism is arranged between opposite corners of the connecting member. In some embodiments, a first aperture and a second aperture are formed through the connecting member. In some embodiments, the first contact member extends through the first aperture and the second contact member extends through the second aperture.

In some embodiments, the hitch-mounted load carrier includes a spring coupled to the clamp assembly and contacting an interior surface of the connecting member. In some embodiments, the spring is configured to bias the clamp assembly away from the interior surface of the hitch receiver.

In some embodiments, the shaft includes a first threaded portion and a second threaded portion. In some embodiments, the first threaded portion is coupled to the first actuator and configured to move the first actuator in a first direction. In some embodiments, the second threaded portion is coupled to the second actuator and configured to move the second actuator in a second direction opposite the first direction.

In some embodiments, the first actuator includes a slot configured to receive the clamp assembly. In some embodiments, the slot includes a sloped surface configured to engage the clamp assembly.

In some embodiments, a hitch-mounted load carrier includes a connecting member and a locking mechanism. In some embodiments, the connecting member is configured to be inserted into a hitch receiver. In some embodiments, the locking mechanism couples to the connecting member and is configured to secure the connecting member inside the hitch receiver. In some embodiments, the locking mechanism includes a first actuator, a second actuator, an actuator plate, a shaft, and a clamp assembly. In some embodiments, the first actuator is disposed in an interior of the connecting member. In some embodiments, the second actuator is opposite the first actuator and disposed in the interior of the connecting member. In some embodiments, the actuator plate couples to the first actuator and is configured to move the first actuator. In some embodiments, the shaft is configured to move at least one of the second actuator and the actuator plate. In some embodiments, the clamp assembly moveably engages with the first actuator and the second actuator. In some embodiments, the clamp assembly is configured to engage an interior surface of the hitch receiver.

In some embodiments, the actuator plate extends from the first actuator towards the shaft and overlaps a portion of the clamp assembly and a portion of the second actuator. In some embodiments, the shaft is rotatably coupled to the second actuator and a fastener. In some embodiments, the fastener is coupled to the actuator plate. In some embodiments, when the shaft is rotated, the second actuator moves in a first direction and the actuator plate moves in a second direction opposite the first direction.

In some embodiments, the actuator plate includes a slot configured to receive a protrusion extending from the clamp assembly. In some embodiments, the protrusion moves within the slot to control movement of the clamp assembly. In some embodiments, the slot extends at an angle relative to a length direction of the shaft.

In some embodiments, a hitch-mounted load carrier includes a connecting member and a securement pin. In some embodiments, the connecting member includes an insertable end configured to be inserted into a hitch receiver. In some embodiments, the securement pin assembly includes a pin body movably coupled to the connecting member at a fixed distance from the insertable end of the connecting member. In some embodiments, the pin body includes a fixed end and a free end configured to extend through aligned apertures formed in the connecting member and the hitch receiver. In some embodiments, the pin body is biased into a locked position where the free end of the pin body is disposed in an interior space of the hitch receiver.

In some embodiments, the securement pin assembly includes a load bracket coupled to the connecting member. In some embodiments, the pin body is rotatably coupled to the load bracket. In some embodiments, the load bracket is configured to transfer vertical loads from the pin body to the connecting member when the pin body is operated as a carrying handle for the hitch-mounted load carrier.

In some embodiments, the securement pin assembly includes a spring coupled to the pin body and the load bracket. In some embodiments, the spring is configured to bias the body into the locked position. In some embodiments, the spring is a torsional spring. In some embodiments, the securement pin assembly includes a housing. In some embodiments, the load bracket, the spring, and a portion of the pin body are disposed within the housing.

In some embodiments, the free end of the pin body includes a hook configured to engage with the aperture of the hitch receiver. In some embodiments, the pin body is a non-linear elongated body.

In some embodiments, the pin body is formed from sheet metal and configured to deflect to dispose the free end in and out of the apertures. In some embodiments, the pin body is rotatably coupled to connecting member. In some embodiments, the securement pin assembly includes an elongated fastener coupled to the connecting member and a spring coupled to the elongated fastener. In some embodiments, the pin body is moveably coupled to the elongated fastener and biased away from the connecting member by the spring along the elongated fastener. In some embodiments, the free end of the pin body includes a bolt configured to extend through the apertures of the connecting member and the hitch receiver.

In some embodiments, a torque limiting handle includes a shaft, a handle body, a control ring, and a torque arm. In some embodiments, the shaft couples to a locking mechanism. In some embodiments, the control ring is disposed in the handle body and couples to the shaft. In some embodiments, the torque arm couples to the handle body and biases into engagement with the control ring. In some embodiments, the torque arm prevents rotation of the control ring when a first torque is applied to the shaft. In some embodiments, the torque arm allows rotation of the control ring when a second torque greater than the first torque is applied to the shaft.

In some embodiments, the control ring includes a recess that receives a protruding end of the torque arm. In some embodiments, a shape of the recess is configured to hold the protruding end in the recess when the first torque is applied to the shaft and to eject the protruding end from the recess when the second torque is applied to the shaft. In some embodiments, the shape of the recess includes an arc having multiple radii.

In some embodiments, a first side of the recess extends approximately perpendicular to a perimeter of the control ring. In some embodiments, a second side of the recess forms an arc that blends in with the perimeter of the control ring.

In some embodiments, the torque limiting handle includes a ratchet mechanism coupled to the shaft and the control ring. In some embodiments, the torque limiting handle includes a spring extending along a length of the handle and coupled to the handle body and the torque arm.

In some embodiments, the torque arm includes first and second torque arms configured to engage the control ring. In some embodiments, the control ring includes a plurality of recesses formed in pairs on opposite sides of the control ring. In some embodiments, the first and second torque arms engage two recesses of the plurality of recesses.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a load carrier including a locking mechanism, a securement pin assembly, and a handle assembly, according to an embodiment.

FIG. 2A illustrates a perspective view of a locking mechanism, according to an embodiment.

FIG. 2B illustrates an exploded view of the locking mechanism of FIG. 2A, according to an embodiment.

FIGS. 3A-3D illustrate side views of the locking mechanism of FIG. 2A in different operating positions, according to embodiments.

FIGS. 4A-4E illustrate side views of different pairs of clamps of a clamp assembly, according to embodiments.

FIGS. 5A-5C illustrate side views of different single-piece clamps of a clamp assembly, according to embodiments.

FIG. 6 illustrates a partial perspective view of a locking mechanism, according to an embodiment.

FIG. 7A illustrates a partial cross-sectional perspective view of a locking mechanism, according to an embodiment.

FIG. 7B illustrates a cutaway perspective view of a locking mechanism, according to an embodiment.

FIGS. 8A and 8B illustrate side views of a protrusion and slot configuration for a locking mechanism, according to an embodiment.

FIG. 9 illustrates a side cross-sectional view of a locking mechanism, according to an embodiment.

FIGS. 10A-10C illustrate side views of a locking mechanism performing a retraction function, according to an embodiment.

FIG. 11 illustrates a front end view of a locking mechanism housed in a connecting member, according to an embodiment.

FIGS. 12A and 12B illustrate front end views of locking mechanisms housed in connecting members, according to embodiments.

FIG. 13A illustrates a side view of a locking mechanism, according to an embodiment.

FIG. 13B illustrates a partial perspective view of the locking mechanism in FIG. 12A, according to an embodiment.

FIG. 14 illustrates a side cross-sectional view of a locking mechanism, according to an embodiment.

FIG. 15A illustrates a perspective view of a locking mechanism, according to an embodiment.

FIG. 15B illustrates an exploded view of the locking mechanism of FIG. 15A, according to an embodiment.

FIG. 16 illustrates a side view of the locking mechanism of FIG. 15A showing operation of the locking mechanism, according to an embodiment.

FIG. 17A illustrates a perspective view of a locking mechanism, according to an embodiment.

FIG. 17B illustrates an exploded view of the locking mechanism of FIG. 17A, according to an embodiment.

FIG. 18 illustrates a side cross-sectional view of the locking mechanism of FIG. 17A, according to an embodiment.

FIG. 19A illustrates an exploded view of a portion of a locking mechanism, according to an embodiment.

FIG. 19B illustrates a side cross-sectional view of a locking mechanism, according to an embodiment.

FIG. 20 illustrates a perspective view of a locking mechanism, according to an embodiment

FIG. 21 illustrates cutaway perspective view of a locking mechanism, according to an embodiment.

FIG. 22 illustrates a perspective view of an end cap and stop plate for a locking mechanism, according to an embodiment.

FIG. 23 illustrates a perspective view of the stop plate of FIG. 22, according to an embodiment.

FIG. 24 illustrates a perspective view of a securement pin assembly, according to an embodiment.

FIG. 25 illustrates a bottom interior view of a securement pin assembly, according to an embodiment.

FIG. 26 illustrates a perspective view of a securement pin assembly inserted into a hitch receiver, according to an embodiment.

FIGS. 27A-27C illustrate top views of securement pin assemblies, according to embodiments.

FIG. 28 illustrates a perspective view of a handle assembly, according to an embodiment.

FIG. 29 illustrates a partial top view of an interior of the handle assembly of FIG. 28, according to an embodiment.

FIG. 30 illustrates a perspective view of a handle assembly, according to an embodiment.

FIG. 31 illustrates a cross-sectional view of the handle assembly of FIG. 30, according to an embodiment.

FIG. 32 illustrates a perspective view of a handle assembly, according to an embodiment.

FIG. 33 illustrates a perspective view of the handle assembly of FIG. 32, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description—A hitch-mounted load carrier includes a connecting member configured to be inserted into a hitch receiver; and a locking mechanism coupled to the connecting member and configured to secure the connecting member inside the hitch receiver, the locking mechanism includes a first actuator disposed in an interior of the connecting member, a second actuator opposite the first actuator and disposed in the interior of the connecting member, a shaft configured to move at least one of the first actuator and the second actuator, and a clamp assembly including a first contact member and a second contact member, wherein the first and second contact members are configured to engage an interior surface of the hitch receiver.

Embodiment 2 of the description—The hitch-mounted load carrier of embodiment 1, wherein a first surface of the clamp assembly contacts the first actuator and a second surface of the clamp assembly contacts the second actuator, and wherein the first and second actuators are configured to translate the clamp assembly.

Embodiment 3 of the description—The hitch-mounted load carrier of embodiment 2, wherein at least one of the first surface and the second surface include an arc-shape.

Embodiment 4 of the description—The hitch-mounted load carrier of embodiment 1, wherein the clamp assembly includes a first clamp and a second clamp.

Embodiment 5 of the description—The hitch-mounted load carrier of embodiment 4, wherein the first clamp moves independently of the second clamp in a first direction.

Embodiment 6 of the description—The hitch-mounted load carrier of embodiment 4, wherein one of the first clamp or the second clamp includes a protrusion, and the other of the first clamp and the second clamp includes a recess configured to receive the protrusion.

Embodiment 7 of the description—The hitch-mounted load carrier of embodiment 6, wherein when the protrusion engages the recess, the first clamp and second clamp move together.

Embodiment 8 of the description—The hitch-mounted load carrier of embodiment 1, wherein the first clamp includes a first side wall and the second clamp includes a second side wall configured to engage the first side wall and transfer a load from the second clamp to the first clamp or receive a load from the first clamp.

Embodiment 9 of the description—The hitch-mounted load carrier of embodiment 1, wherein the clamp assembly further includes a bridge connecting the first and second contact members.

Embodiment 10 of the description—The hitch-mounted load carrier of embodiment 1, wherein the locking mechanism is arranged between opposite corners of the connecting member.

Embodiment 11 of the description—The hitch-mounted load carrier of embodiment 1, wherein a first aperture and a second aperture are formed through the connecting member, and wherein the first contact member extends through the first aperture and the second contact member extends through the second aperture.

Embodiment 12 of the description—The hitch-mounted load carrier of embodiment 1, further including a spring coupled to the clamp assembly and contacting an interior surface of the connecting member, wherein the spring is configured to bias the clamp assembly away from the interior surface of the hitch receiver.

Embodiment 13 of the description—The hitch-mounted load carrier of embodiment 1, wherein the shaft includes a first threaded portion and a second threaded portion.

Embodiment 14 of the description—The hitch-mounted load carrier of embodiment 13, wherein the first threaded portion is coupled to the first actuator and configured to move the first actuator in a first direction, and wherein the second threaded portion is coupled to the second actuator and configured to move the second actuator in a second direction opposite the first direction.

Embodiment 15 of the description-The hitch-mounted load carrier of embodiment 1, wherein the first actuator includes a slot configured to receive the clamp assembly, and wherein the slot includes a sloped surface configured to engage the clamp assembly.

Embodiment 16 of the description-A hitch-mounted load carrier includes a connecting member configured to be inserted into a hitch receiver; and a locking mechanism coupled to the connecting member and configured to secure the connecting member inside the hitch receiver, the locking mechanism including a first actuator disposed in an interior of the connecting member, a second actuator opposite the first actuator and disposed in the interior of the connecting member, an actuator plate coupled to the first actuator and configured to move the first actuator, a shaft configured to move at least one of the second actuator and the actuator plate, and a clamp assembly moveably engaged with the first actuator and the second actuator, wherein the clamp assembly is configured to engage an interior surface of the hitch receiver.

Embodiment 17 of the description-The hitch-mounted load carrier of embodiment 16, wherein the actuator plate extends from the first actuator towards the shaft and overlaps a portion of the clamp assembly and a portion of the second actuator.

Embodiment 18 of the description-The hitch-mounted load carrier of embodiment 16, wherein the shaft is rotatably coupled to the second actuator and a fastener, wherein the fastener is coupled to the actuator plate, and wherein when the shaft is rotated, the second actuator moves in a first direction and the actuator plate moves in a second direction opposite the first direction.

Embodiment 19 of the description-The hitch-mounted load carrier of embodiment 16, wherein the actuator plate includes a slot configured to receive a protrusion extending from the clamp assembly, and wherein the protrusion moves within the slot to control movement of the clamp assembly.

Embodiment 20 of the description-The hitch-mounted load carrier of embodiment 19, wherein the slot extends at an angle relative to a length direction of the shaft.

Embodiment 21 of the description-A hitch-mounted load carrier includes a connecting member including an insertable end configured to be inserted into a hitch receiver; and a securement pin assembly including a pin body movably coupled to the connecting member at a fixed distance from the insertable end of the connecting member, wherein the pin body includes a fixed end and a free end configured to extend through aligned apertures formed in the connecting member and the hitch receiver, wherein the pin body is biased into a locked position where the free end of the pin body is disposed in an interior space of the hitch receiver.

Embodiment 22 of the description-The hitch-mounted load carrier of embodiment 21, wherein the securement pin assembly includes a load bracket coupled to the connecting member, and wherein the pin body is rotatably coupled to the load bracket.

Embodiment 23 of the description-The hitch-mounted load carrier of embodiment 22, wherein the load bracket is configured to transfer vertical loads from the pin body to the connecting member when the pin body is operated as a carrying handle for the hitch-mounted load carrier.

Embodiment 24 of the description-The hitch-mounted load carrier of embodiment 22, wherein the securement pin assembly includes a spring coupled to the pin body and the load bracket, wherein the spring is configured to bias the body into the locked position.

Embodiment 25 of the description-The hitch-mounted load carrier of embodiment 24, wherein the spring is a torsional spring.

Embodiment 26 of the description-The hitch-mounted load carrier of embodiment 24, wherein the securement pin assembly includes a housing, and wherein the load bracket, the spring, and a portion of the pin body are disposed within the housing.

Embodiment 27 of the description-The hitch-mounted load carrier of embodiment 21, wherein the free end of the pin body includes a hook configured to engage with the aperture of the hitch receiver.

Embodiment 28 of the description-The hitch-mounted load carrier of embodiment 21, wherein the pin body is a non-linear elongated body.

Embodiment 29 of the description-The hitch-mounted load carrier of embodiment 21, wherein the pin body is formed from sheet metal and configured to deflect to dispose the free end in and out of the apertures.

Embodiment 30 of the description-The hitch-mounted load carrier of embodiment 29, wherein the pin body is rotatably coupled to connecting member.

Embodiment 31 of the description-The hitch-mounted load carrier of embodiment 29, wherein the securement pin assembly includes an elongated fastener coupled to the connecting member and a spring coupled to the elongated fastener, and wherein the pin body is moveably coupled to the elongated fastener and biased away from the connecting member by the spring along the elongated fastener.

Embodiment 32 of the description-The hitch-mounted load carrier of embodiment 29, wherein the free end of the pin body includes a bolt configured to extend through the apertures of the connecting member and the hitch receiver.

Embodiment 33 of the description-A torque limiting handle includes a shaft coupled to a locking mechanism; a handle body; a control ring disposed in the handle body and coupled to the shaft; and a torque arm coupled to the handle body and biased into engagement with the control ring, wherein the torque arm prevents rotation of the control ring when a first torque is applied to the shaft, and wherein the torque arm allows rotation of the control ring when a second torque greater than the first torque is applied to the shaft.

Embodiment 34 of the description-The torque limiting handle of embodiment 33, wherein the control ring includes a recess that receives a protruding end of the torque arm, and wherein a shape of the recess is configured to hold the protruding end in the recess when the first torque is applied to the shaft and to eject the protruding end from the recess when the second torque is applied to the shaft.

Embodiment 35 of the description-The torque limiting handle of embodiment 34, wherein the shape of the recess includes an arc having multiple radii.

Embodiment 36 of the description-The torque limiting handle of embodiment 34, wherein a first side of the recess extends approximately perpendicular to a perimeter of the control ring, and a second side of the recess forms an arc that blends in with the perimeter of the control ring.

Embodiment 37 of the description-The torque limiting handle of embodiment 33, further including a ratchet mechanism coupled to the shaft and the control ring.

Embodiment 38 of the description-The torque limiting handle of embodiment 33, further including a spring extending along a length of the handle and coupled to the handle body and the torque arm.

Embodiment 39 of the description-The torque limiting handle of embodiment 33, wherein the torque arm includes first and second torque arms configured to engage the control ring.

Embodiment 40 of the description-The torque limiting handle of embodiment 39, wherein the control ring includes a plurality of recesses formed in pairs on opposite sides of the control ring, and wherein the first and second torque arms engage two recesses of the plurality of recesses.

Embodiments of the load carriers disclosed herein can be used with, for example, but not limited to, a bicycle carrier(s) or a cargo container. More specifically, the load carriers are vehicle mounted load carrier, for example, a hitch-mounted bicycle carrier or cargo carrier that can be attached to hitch receiver of a vehicle.

As discussed above, it is important to securely mount a load carrier to a vehicle. Hitch-mounted load carriers can have one or more attachment mechanisms to attach and secure the load carrier to the vehicle. For example, a first attachment mechanism can be disposed inside the vehicle hitch and can provide pressure on an interior surface of the vehicle hitch for a friction-fit attachment, and a second attachment mechanism can include a securement pin that is inserted from an external position and through aligned apertures in the hitch receiver and the load carrier insert connector.

The interior mechanisms can lose torque over time (also referred to herein as torque-loss). Further, the mechanisms may damage or deform the interior of the vehicle hitch over time, leading to greater torque-loss and difficulty for a user. Torque-loss causes the need for the user to frequently tighten the mechanism, and can result in the load carrier becoming detached, causing possible damage to the load carrier, the carried items, and/or vehicles. Depending on the strength of the user attaching the load carrier, the weight of the load carrier, and other environmental conditions, it can be progressively difficult over time to secure the load carrier to the hitch receiver with the attachment mechanism.

It is important for the locking mechanism to include features that reduce torque-loss during use and further to provide tools to a user to correctly torque the locking mechanism when installed to a vehicle hitch. In addition, it is important to maximize the friction-fit between the hitch receiver and the locking mechanism for a given torque to reduce the tendency to over-torque the locking mechanism to achieve a desired securement. The present disclosure provides embodiments of a locking mechanism that includes two contact members to increase contact area with the hitch receiver, and corresponding friction. Two contact members also provides independent movement of the contact members to accommodate imperfections and unevenness on the interior surface(s) of the hitch receiver that allows for a consistent force applied by the locking mechanism to the hitch receiver.

Securement pins provide a secondary safety system to secure the load carrier to the vehicle. Self-locating pins make installing a load carrier easier by performing one of the securing functions of the load carrier automatically. The present disclosure provides embodiments of securement pins that are configured to enable or accommodate repetitive, same location positioning of the engaging end of the securement pin on the hitch receiver. In addition, it can be beneficial for a load carrier to have additional lifting points to help moving and positioning the load carrier relative to the hitch receiver for installation or storage. The present disclosure provides securement pin embodiments that can also be used as a handle for the load carrier that is strong enough to support the weight of the load carrier.

Embodiments of load carrier apparatuses, systems, and methods as discussed below can provide versatility for securing load carriers to vehicles that are easy to use and provide robust, secure installation of the load carrier.

### Example Hitch Connection Device

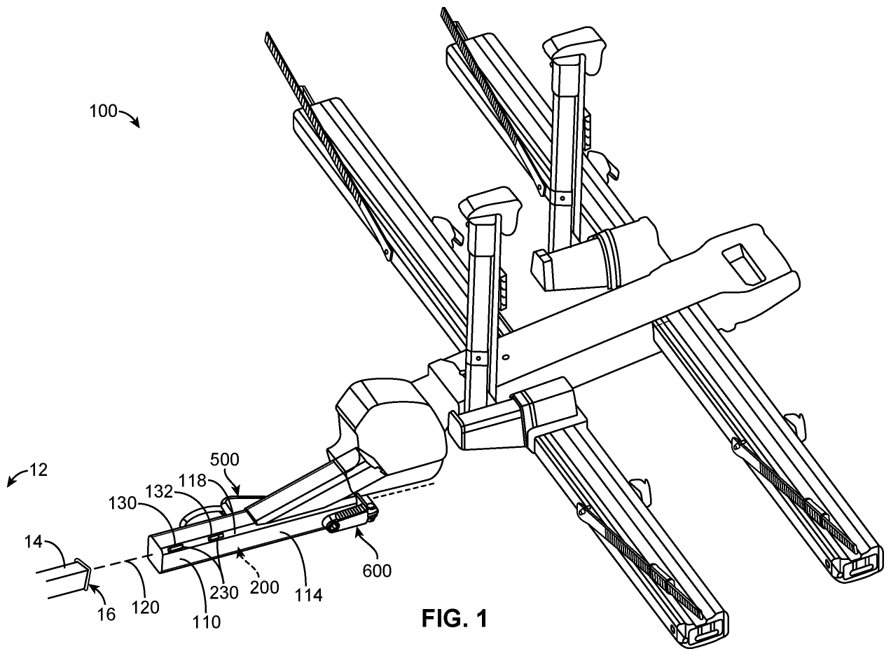

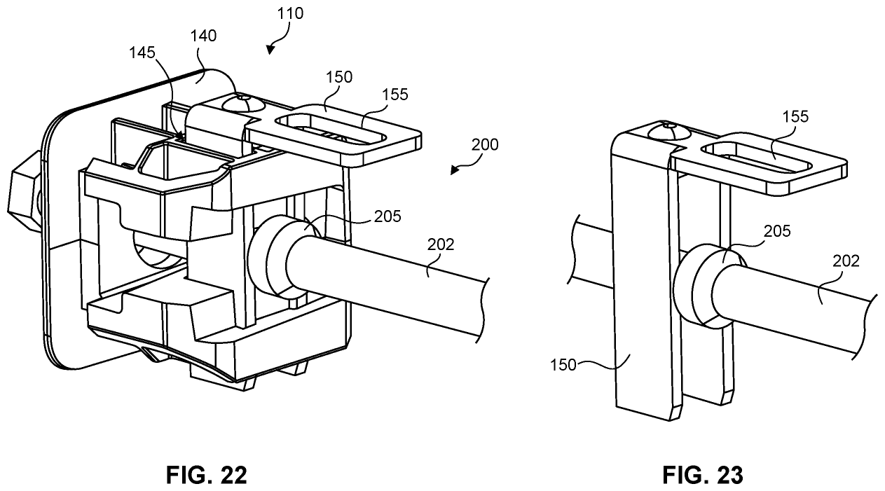

FIGS. 1-23 illustrate locking mechanisms 200 for a load carrier 100, according to embodiments. Locking mechanisms 200 can be configured to secure a load carrier 100 to a vehicle. Locking mechanisms 200 can include multiple contact surfaces that engage an interior surface 16 of a hitch receiver 14 to accommodate surface irregularities in the hitch receiver 14 and increase a clamping friction force between the locking mechanisms 200 and the hitch receiver 14. Although locking mechanism 200 is shown in FIGS. 1-23 as a stand-alone system, the embodiments of this disclosure can be used with other apparatuses and/or systems, such as, but not limited to securement pin 500 and handle assembly 600.

Load carrier 100 can be configured to be coupled to a vehicle 12 and secure a load to the load carrier 100 for transport by the vehicle 12. As shown, for example, in FIG. 1, load carrier 100 can be a bicycle carrier configured to secure one or more bicycles to the carrier. In some embodiments, load carrier 100 can be or support a cargo box configured to be secured to the vehicle. Vehicle 12 can include a hitch receiver 14 configured to receive a connecting member 110 of load carrier 100. In some embodiments, connecting member 110 can have a size and shape corresponding to interior surface 16 of hitch receiver 14, for example, a 1.25-inch or a 2-inch hitch receiver. In some embodiments, connecting member 110 can have a hollow square or rectangle shape with rounded corners when viewed in cross-section. Generally, connecting member 110 is a resilient material, for example, but not limited to, steel or other metal.

Connecting member 110 is configured to be inserted into hitch receiver 14 and house locking mechanism 200 in an interior 116 of connecting member 110. Connecting member 110 can include an exterior surface 114 that faces interior surface 16 of hitch receiver 14, an interior surface 112 opposite exterior surface 114, and longitudinal axis 120 extending along a length of connecting member 110. In some embodiments, connecting member 110 can be a hollow cuboid with a cross-sectional thickness, for example, about 1 to 10 mm. Connecting member 110 can include a first aperture 130 and a second aperture 132, each extending through interior surface 112 and exterior surface 114. In the illustrative embodiment shown in FIG. 1, first and second apertures 130, 132 can be configured to receive a clamp assembly 230 of locking mechanism 200. In some embodiments, first and second apertures 130, 132 can extend through a corner 118 of connecting member 110.

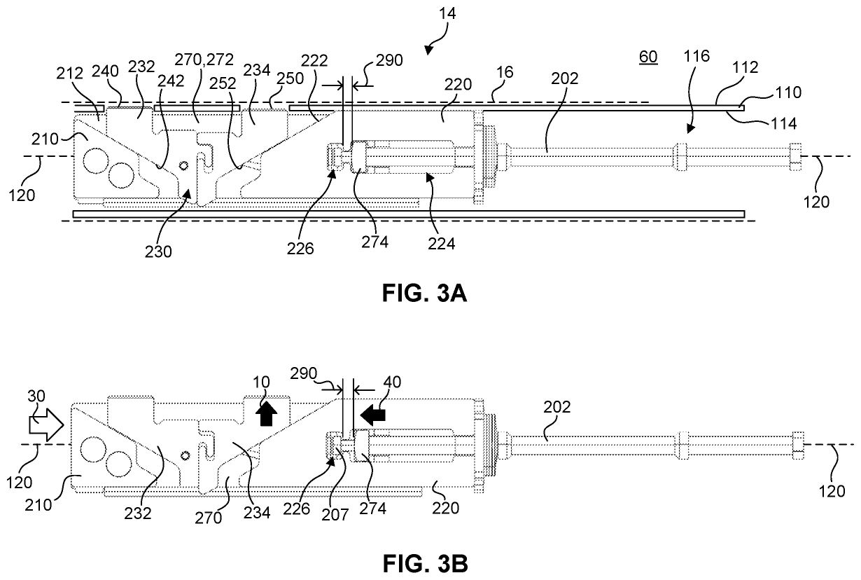

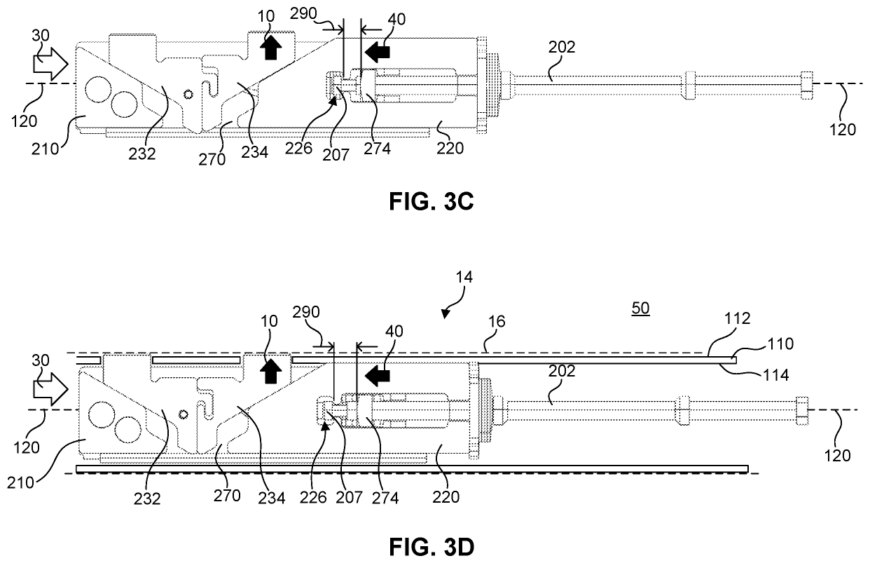

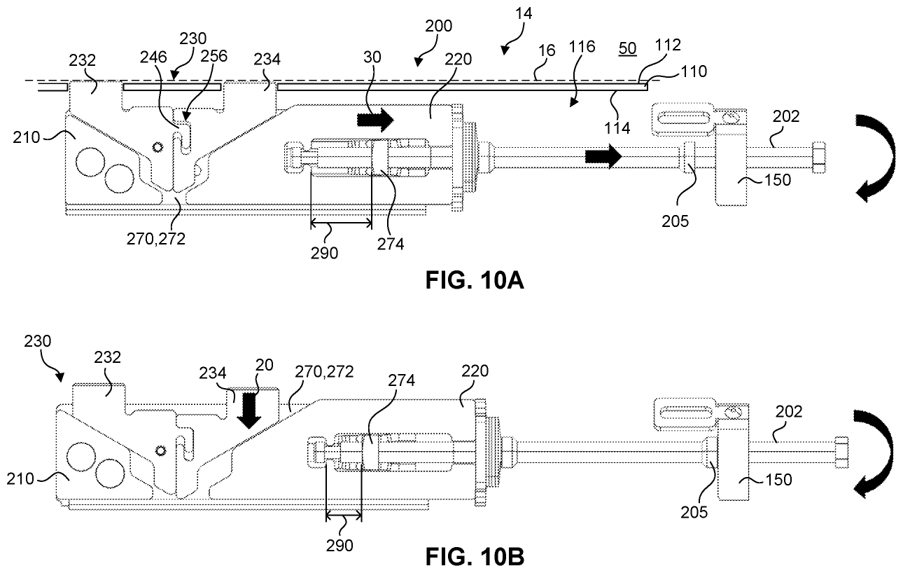

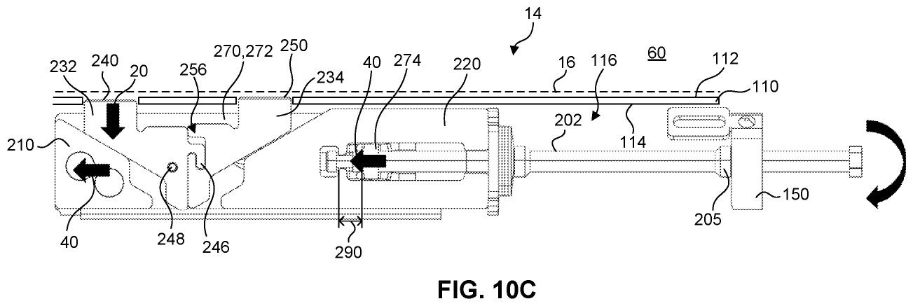

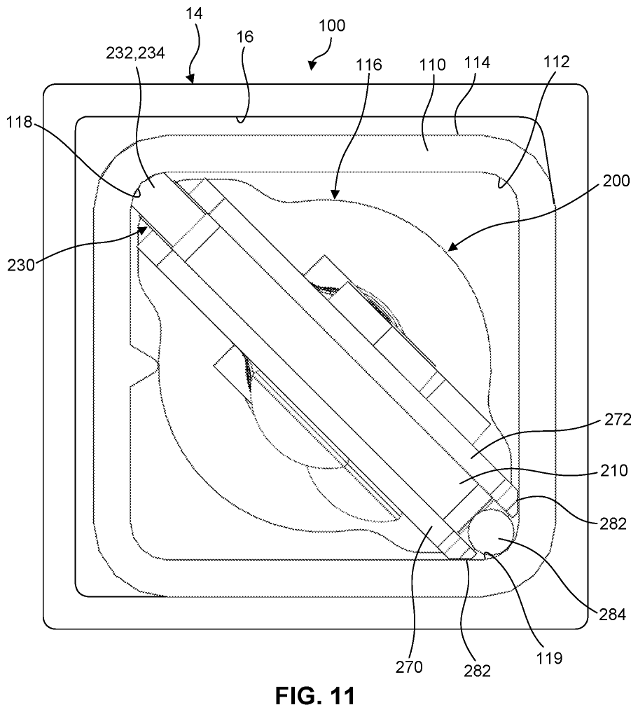

Locking mechanism 200 can be disposed in interior 116 of connecting member 110 and include a clamp assembly 230 that can at least partially extend out of connecting member 110 to engage hitch receiver 14. In some embodiments, locking mechanism 200 can be attached to connecting member 110. As shown, for example, in FIG. 3A-D, locking mechanism 200 can be configured to move clamp assembly 230 in a first direction 10 and into engagement with interior surface 16 of hitch receiver 14 to provide a locked position 50. As shown, for example, in FIG. 10A-C, locking mechanism 200 can be configured to move clamp assembly 230 in a second direction 20, opposite first direction 10, away from interior surface 16 of hitch receiver 14 to provide an unlocked position 60.

In some embodiments, in the unlocked position 60, claim assembly 230 is retracted into connecting member 110 such that a first contact member 240 is recessed in first aperture 130 below exterior surface 114, and a second contact member 250 is recessed in second aperture 132 below exterior surface 114. In some embodiments, first contact member 240 and/or second contact member 250 can protrude beyond exterior surface 114 in unlocked position 60. In some embodiments, contact members 240, 250 can include padding that engages with interior surface 16 of hitch receiver 14 and accommodates surface irregularities and absorbs shock impacts during transportation of load carrier 100. Locking mechanism 200 can be moved between the locked position 50 and the unlocked position 60, for example, by handle assembly 600 (e.g., by rotating handle assembly 600), which radially retracts or protrudes clamp assembly 230.

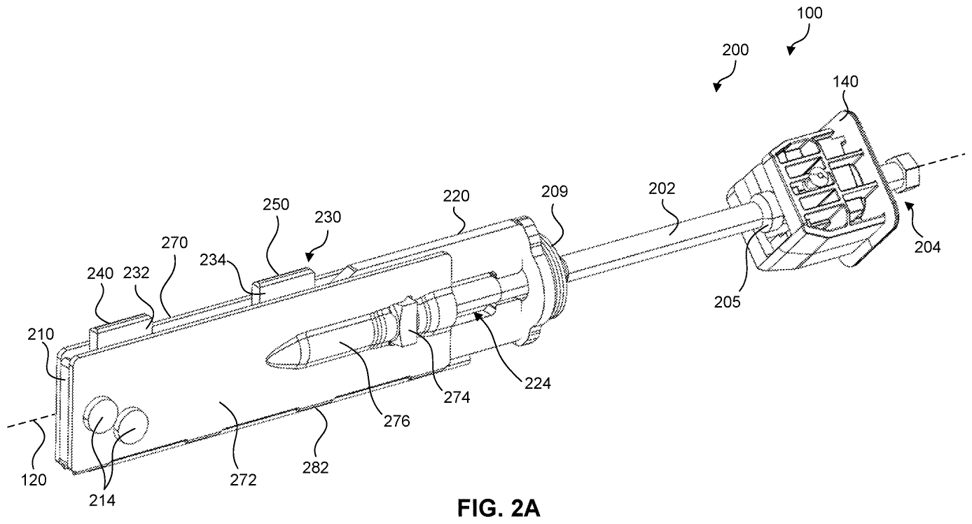

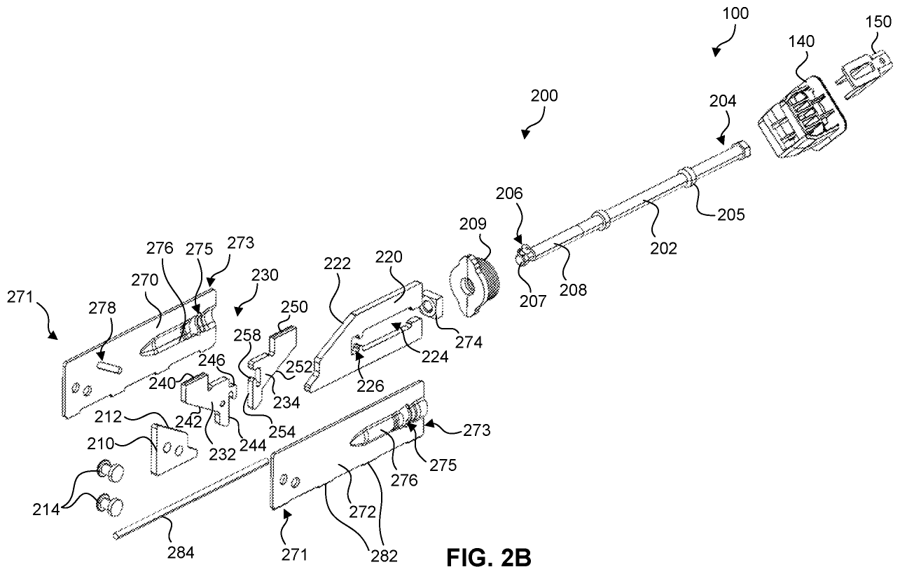

Locking mechanism 200 can include a shaft 202, a first actuator 210, a second actuator, 220, clamp assembly 230, a first actuator plate 270, and/or a second actuator plate 272 as shown, for example, in FIGS. 2A-3D. In some embodiments, shaft 202 can be rotated, which linearly translates first actuator 210 and second actuator 220 along axis 120. In some embodiments, first actuator 210 can be configured to move in a third direction 30 and second actuator 220 can be configured to move in a fourth direction 40, opposite third direction 30. In some embodiments, first actuator 210 can move in third direction 30 and contact a first surface 242 of clamp assembly 230 to linearly translate clamp assembly 230 in first direction 10. In some embodiments, first direction 10 is approximately perpendicular to third direction 30 and/or fourth direction 40. In some embodiments, second actuator 220 can move in fourth direction 40 and contact a second surface 252 of clamp assembly 230 to linearly translate clamp assembly 230 in first direction 10. In some embodiments, tolerances in the assembly of the locking mechanism 200 allow clamp assembly 230 to translate and wiggle to adjust to the tolerances in the assembly and any gaps that may form between assembly components.

Shaft 202 can extend along axis 120 and be coupled to handle 600 and second actuator 220, as shown, for example, in FIGS. 2A-3D. Shaft 202 can include a first end 204, a second end 206, a threaded portion 208, and/or a spring 209. Shaft 202 can couple with handle 600 at first end 204, such that a user can operate handle 600, for example, to rotate shaft 202. Shaft 202 can rotatably couple with second actuator 220 at second end 206. In some embodiments, shaft 202 is threadably coupled to second actuator 220 such that rotation of shaft 202 moves second actuator 220 in the third direction 30 or the fourth direction 40 depending on the direction of rotation of shaft 202 (e.g., clockwise or counter-clockwise). As shown, for example, in FIGS. 2A-3D, second end 206 of shaft 202 includes a flange 207 that engages a retaining slot 226 of the second actuator 220. Shaft 202 can be threadably coupled to a fastener 274 along threaded portion 208 such that rotation of shaft 202 relative to fastener 274 causes flange 207 to exert a force on retaining slot 226 and move second actuator 220. In some embodiments, fastener 274 can be a nut, a flange, or a plate with a threaded aperture.

Spring 209 can couple to shaft 202 and exert a force on second actuator 220 to limit torque-loss in locking mechanism 200. In the illustrative embodiment shown, for example, in FIGS. 2A-3D, spring 209 can be fixed to shaft 202 between threaded portion 208 and first end 204. In some embodiments, spring 209 can engage second actuator 220 and exert a force on second actuator 220 in fourth direction 40. During transportation of load carrier 100, bumps and jostling of load carrier 100 may increase and reduce forces acting on locking mechanism 200 from hitch receiver 14. This variation of forces may cause small movements in clamp assembly 230, first actuator 210, and/or second actuator 220, potentially reducing the friction-fit between locking mechanism 200 and hitch receiver 14. Spring 209 can be configured to maintain a positive force in locking mechanism 200 such that the friction-fit between locking mechanism 200 and hitch receiver 14 is maintained throughout operation and transportation of load carrier 100 and thereby limited torque-loss in the system.

Second actuator 220 is configured to translate in the third and/or fourth directions 30, 40 and cause clamp assembly 230 to translate in first and second directions 10, 20 to engage and disengage with hitch receiver 14. In some embodiments, second actuator 220 can be configured to linearly translate along axis 120. For example, second actuator 220 can linearly translate along axis 120 as a function of threads along threaded portion 208 of shaft 202 rotating. Second actuator 220 can include a second actuation surface 222, an elongated aperture 224, and/or retaining slot 226 as shown, for example, in FIGS. 2A-3D. In the illustrative embodiment shown, for example, in FIG. 2B, second actuator 220 is a thin plate. In some embodiments, second actuator 220 can have a thickness between 3 millimeters and 12 millimeters. In some embodiments, second actuator 220 can have a thickness between 4 millimeters and 10 millimeters. In some embodiments, second actuator 220 can have a thickness of approximately 5 millimeters. In some embodiments, second actuator 220 can be made of a rigid material, for example, metals (e.g., steel, stainless steel, iron, aluminum, tungsten, lead, titanium, etc.), metal oxides, ceramics, polymers, or other similar rigid material.

In some embodiments, second actuation surface 222 can be an angled surface relative to axis 120 and can be configured to engage a second surface 252 of clamp assembly 230 as shown, for example, in FIG. 3A-D. Second actuation surface 222 can be configured to transfer axial movement of second actuator 220 along axis 120 into radial movement of clamp assembly 230 in the first and/or second directions 10, 20. In some embodiments, second actuation surface 222 can be angled between 0 degrees and 90 degrees relative to axis 120. In some embodiments, second actuation surface 222 can be angled between 5 degrees and 85 degrees relative to axis 120. In some embodiments, second actuation surface 222 can be angled between 25 degrees and 60 degrees relative to axis 120. In some embodiments, second actuation surface 222 can be angled at approximately 30 degrees relative to axis 120. In some embodiments, second actuation surface 222 can be angled at approximately 45 degrees relative to axis 120. In some embodiments, second actuation surface 222 can be angled to complement second surface 252 of clamp assembly 230. In some embodiments, second actuation surface 222 can have an angle different than second surface 252 of clamp assembly 230 such that a contact area is reduced between the surfaces that may also reduce friction in the mechanism. In some embodiments, second actuation surface 222 surface can have an angle equal to but opposite a first actuation surface 212 of first actuator 210 such that first and second actuators 210, 220 translate clamp assembly 230 at approximately the same rate.

In some embodiments, elongated aperture 224 can be formed in second actuator 220 along axis 120 as shown, for example, in FIGS. 2A-3D. Elongated aperture 224 can be connected with retaining slot 226 such that shaft 202 extends through elongated aperture 224 and into retaining slot 226. Elongated aperture 224 can be sized to accommodate fastener flange 274 such that second actuator 220 and fastener 274 can translate relative to one another. Retaining slot 226 can be configured to receive flange 207 of shaft 202. Retaining slot 226 can be configured to transfer forces and movement of shaft 202 to second actuator 220.

First actuator 210 is configured to translate in the third and/or fourth directions 30, 40 and cause clamp assembly 230 to translate in first and second directions 10, 20 to engage and disengage with hitch receiver 14. First actuator 210 can be disposed opposite second actuator 220, so that a first actuation surface 212 of first actuator 210 faces toward second actuation surface 222 of second actuator 220 as shown, for example, in FIGS. 2B-3D. In the illustrative embodiment shown, for example, in FIG. 2B, first actuator 210 is a thin plate. In some embodiments, first actuator 210 can have a thickness between 3 millimeters and 12 millimeters. In some embodiments, first actuator 210 can have a thickness between 4 millimeters and 10 millimeters. In some embodiments, first actuator 210 can have a thickness of approximately 5 millimeters. In some embodiments, first actuator 210 can be made of a rigid material, for example, metals (e.g., steel, stainless steel, iron, aluminum, tungsten, lead, titanium, etc.), metal oxides, ceramics, polymers, or other similar rigid material.

In some embodiments, first actuation surface 212 can be an angled surface relative to axis 120 and can be configured to engage a first surface 242 of clamp assembly 230 as shown, for example, in FIG. 3A-D. First actuation surface 212 can be configured to transfer axial movement of first actuator 210 along axis 120 into radial movement of clamp assembly 230 in the first and/or second directions 10, 20. In some embodiments, first actuation surface 212 can be angled between 0 degrees and 90 degrees relative to axis 120. In some embodiments, first actuation surface 212 can be angled between 5 degrees and 85 degrees relative to axis 120. In some embodiments, first actuation surface 212 can be angled between 25 degrees and 60 degrees relative to axis 120. In some embodiments, first actuation surface 212 can be angled at approximately 30 degrees relative to axis 120. In some embodiments, first actuation surface 212 can be angled at approximately 45 degrees relative to axis 120. In some embodiments, first actuation surface 212 can be angled to complement first surface 242 of clamp assembly 230. In some embodiments, first actuation surface 212 can have an angle different than first surface 242 of clamp assembly 230 such that a contact area is reduced between the surfaces that may also reduce friction in the mechanism.

First actuator 210 can be coupled to first actuator plate 270 and second actuator plate 272 as shown, for example, in FIGS. 2A-3D. In some embodiments, first actuator plate 270 and second actuator plate 272 are substantially similar and include a first end 271, a second end 273 opposite first end 271, a translation slot 275, and/or an elongated recess 276 as shown, for example, in FIGS. 2A-3D. First actuator 210 can be coupled to first end 271 of first and second actuator plates 270, 272 by fasteners 214. In some embodiments, fasteners 214 can be diagonally offset from one another such that first actuator 210 and actuator plates 270, 272 are fixed in an orientation relative to one another. In some embodiments, first actuator 210 can be coupled to actuator plates 270, 272 by rivets, bolts, spring pins, welding, adhesives, or any other suitable attachment.

In some embodiments, actuator plates 270, 272 extend along axis 120 to at least partially overlap first actuator 210, clamp assembly 230, and second actuator 220 as shown, for example, in FIG. 2A. In some embodiments, first and second actuator plates 270, 272 can be thin plates. In some embodiments, first and second actuator plates 270, 272 can have a thickness between 3 millimeters and 12 millimeters. In some embodiments, first and second actuator plates 270, 272 can have a thickness between 4 millimeters and 10 millimeters. In some embodiments, first and second actuator plates 270, 272 can have a thickness of approximately 5 millimeters. In some embodiments, first actuator plate 270 and second actuator plate 272 can be configured to sandwich a portion of locking assembly 200. In the illustrative embodiment shown, for example, in FIG. 2A, first actuator 210 is disposed between actuator plates 270, 272. In some embodiments, first actuator 210 is at least partially disposed between actuator plates 270, 272. In the illustrative embodiment shown, for example, in FIG. 2A, clamp assembly 230 and second actuator 220 are at least partially disposed between actuator plates 270, 272. In some embodiments, first actuator 210, second actuator 220, and clamp assembly 230 are entirely covered by actuator plates 270, 272 except when contact member 240, 250 of clamp assembly 230 engage hitch receiver 14 in the locked position 50. In some embodiments, locking mechanism 200 only includes one actuation plate 270 extending on one side of locking mechanism 200.

Recess 276 can be formed in actuation plates 270, 272 and configured to accommodate a width of shaft 202 as shown, for example, in FIG. 2A. Recess 276 can extend from second end 273 along axis 120 such that actuation plates 270, 272 form an opening configured to receive shaft 202. A length of recess 276 can be sized to accommodate relative movements of shaft 202 and actuation plates 270, 272 when locking mechanism 200 is moved between the locked position 50 and unlocked position 60.

Translation slot 275 can be formed through actuation plates 270, 272 along a length of recess 276 as shown, for example, in FIGS. 2A and 2B. Translation slot 275 can be configured to receive fastener 274. In some embodiments, translation slot 275 can be sized to have equal dimensions to fastener 274 to minimize gaps between translation slot 275 and fastener 274. In some embodiments, translation slot 275 forms translation surfaces 277 in recess 276. Translation surface 277 can be configured to engage with fastener 274 such that movement of fastener flange is transferred into actuator plates 270, 272.

Interaction between fastener 274, shaft 202, second actuator 220, actuator plate 270, 272, and first actuator 210 can facilitate opposite movements of second actuator 220 relative to first actuator 210 in third and fourth directions 30, 40 as shown, for example, in FIGS. 3A-3D. For example, shaft 202 can be rotated and the threaded engagement between shaft 202 and fastener 274 can move shaft 202 and second actuator 220 in fourth direction 40. As shown, for example, in FIGS. 3A and 3B, a distance 290 between retaining slot 226 and fastener 274 increases during this initial stage.

When second actuator 220 experiences a resisting force (e.g., frictional forces between second actuation surface 222 of second actuator 220 and second surface 252 of clamp assembly 230, or clamp assembly 230 initially engaging hitch receiver 14), movement of second actuator 220 and shaft 202 can be limited, and continued rotation of shaft 202 can translate fastener flange 274 in the third direction 30 along threaded portion 208 toward first end 204 of shaft 202. As shown, for example, in FIGS. 3B and 3C, distance 290 between retaining slot 226 and fastener flange 274 increases further during this stage.

Translation of fastener flange 274 in third direction 30 moves actuation plates 270, 272 and first actuator 210 such that first actuator 210 moves in third direction 30 and closer to second actuator 220. Continued rotation of shaft 202 can continue the movement and interactions of fastener flange 274, shaft 202, second actuator 220, actuator plate 270, 272, and first actuator 210 described above and shown, for example, in FIGS. 3C and 3D. Movement and interaction of locking mechanism 200 can continue until both clamp contact members 240, 250 of clamp assembly 230 engage with hitch receiver 14 in locked position 50 and form the desired friction-fit between locking mechanism 200 and hitch receiver 14.

Clamp assembly 230 can be configured to translate radially outward from axis 120 to engage with hitch receiver 14. As shown, for example, in FIGS. 3A-3D, movement of first actuator 210 in third direction 30 and second actuator 220 in fourth direction 40 towards one another can move clamp assembly 230 outward in first direction 10. In some embodiments, clamp assembly 230 can include first clamp 232 and second clamp 234. In the illustrative embodiments shown, for example, in FIGS. 2A-4E and 10A-10C, first clamp 232 and second clamp 234 are separate components that can move independently from one another.

In some embodiments, first clamp 232 can be actuated by first actuator 210 and include first contact member 240, first surface 242, and first side wall 244 as shown, for example, in FIGS. 2B-4E. In some embodiments, first clamp 232 can be made of a rigid material, for example, metals (e.g., steel, stainless steel, iron, aluminum, tungsten, lead, titanium, etc.), metal oxides, ceramics, polymers, or other similar rigid material. In some embodiments, first contact member 240 can be configured to extend through first aperture 130 in connecting member 110 and engage with interior surface 16 of hitch receiver 14. In some embodiments, first contact member 240 is a flat surface configured to contact interior surface 16 of hitch receiver 14 when in locked position 50. In some embodiments, first contact member 240 can be an arm, a plate, a surface, a bearing, a rod, or a wedge.

In some embodiments, first surface 242 can contact first actuation surface 212 of first actuator 210 as shown, for example, in FIGS. 3A-3D. First surface 242 can be angled relative to axis 120. In some embodiments first surface 242 can be angled between 20 degrees and 70 degrees. In some embodiments, first surface 242 can be angled to complement first actuation surface 212 of first actuator 210. In some embodiments, first surface 242 can have an angle different than first actuation surface 212 such that a contact area is reduced between the surfaces that may also reduce friction in the mechanism. In some embodiments, first surface 242 can have a curvature a shown, for example, in FIG. 5C.

Second clamp 234 can be the same or similar to first clamp 232 described above and shown in FIGS. 2B-4E and can include any of the features described with respect thereto. In some embodiments, second clamp 234 can be actuated by second actuator 220 and include second contact member 250, second surface 252, and second side wall 254 as shown, for example, in FIGS. 2B-4E. In some embodiments, second clamp 234 can be made of a rigid material, for example, metals (e.g., steel, stainless steel, iron, aluminum, tungsten, lead, titanium, etc.), metal oxides, ceramics, polymers, or other similar rigid material. In some embodiments, second contact member 250 can be configured to extend through second aperture 132 in connecting member 110 and engage with interior surface 16 of hitch receiver 14. In some embodiments, second contact member 250 is a flat surface configured to contact interior surface 16 of hitch receiver 14 when in locked position 50. In some embodiments, second contact member 250 can be an arm, a plate, a surface, a bearing, a rod, or a wedge.

In some embodiments, second surface 252 can contact second actuation surface 222 of second actuator 220 a shown, for example, in FIGS. 3A-3D. Second surface 252 can be angled relative to axis 120. In some embodiments second surface 252 can be angled between 20 degrees and 70 degrees. In some embodiments, second surface 252 can be angled to complement second actuation surface 222 of second actuator 220. In some embodiments, second surface 252 can have an angle different than second actuation surface 222 such that a contact area is reduced between the surfaces that may also reduce friction in the mechanism. In some embodiments, second surface 252 can have a curvature.

In the illustrative embodiments shown, for example, in FIGS. 2B-4D, first side wall 244 of first clamp 232 can contact second side wall 254 of second clamp 234. First side wall 244 and second side wall 254 can be configured transfer loads between first clamp 232 and second clamp 234 during movement from unlocked position 60 to locked position 50. For example, first contact member 240 of first clamp 232 can engage interior surface 16 of hitch receiver 14 before second contact member 250 of second clamp 234. Engagement between first contact member 240 and interior surface 16 can form a reaction force or load in second direction 20 that is redirected in third direction 30 by interaction between first surface 242 and first actuation surface 212. The force or load can be transferred to second clamp 234 from first clamp 232 by engagement between first and second side walls 244, 254. The force or load can be redirected by interaction between second actuation surface 222 and second surface 252 into the first direction 10. Second contact member 250 can either move in first direction 10 or exert a force in first direction 10 on interior surface 16 of hitch receiver 14. In some embodiments, the transfer of loads from first clamp 232 to second clamp 234 and back again can balance the forces across the contact members 240, 250. In some embodiments, first side wall 244 and second side wall 254 can be configured guide one another during translation in first and second direction 10, 20.

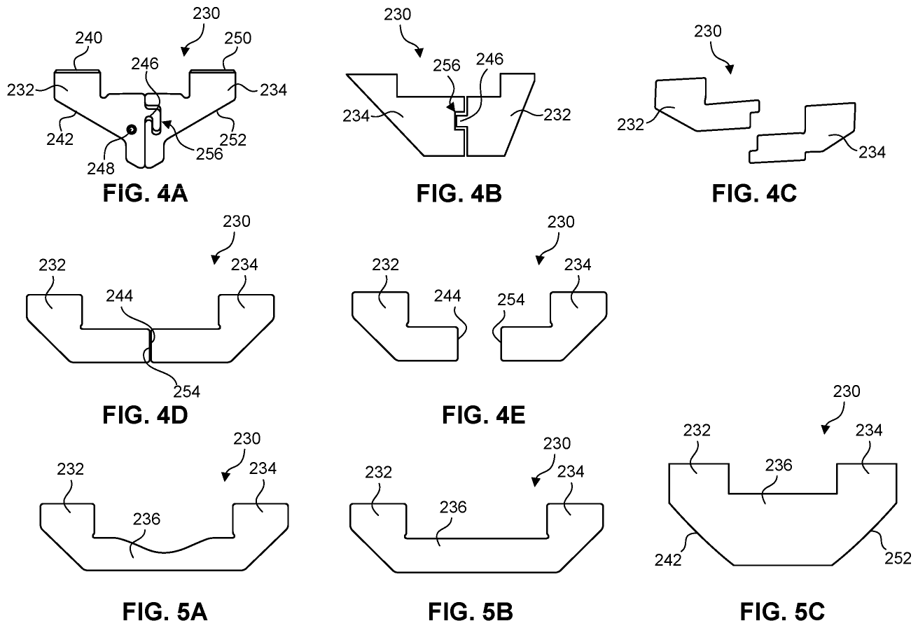

As shown, for example, in FIGS. 2B, 3A-3D, 4A, and 4B, first side wall 244 can include a protrusion 246 and second side wall 254 can include a recess 256 configured to receive protrusion 246 (or vice versa). In some embodiments, protrusion 246 and recess 256 can be L-shaped and include portions that extend parallel to first and second side walls 244, 254 as shown, for example, in FIGS. 2B-4A. In some embodiments, a gap can be formed between protrusion 246 and recess 256 such that first clamp 232 can move relative to second clamp 234 without protrusion 246 contacting recess 256. In some embodiments, protrusion 246 can be configured to engage recess 256 such that first clamp 232 and second clamp 234 move together between locked and unlocked positions 50, 60. In some embodiments, protrusion 246 extend perpendicularly away from first side wall 244 as shown, for example, in FIG. 4B. In some embodiments, first side wall 244 and second side wall 254 can include stepped geometry configured to engage in the first or second directions as shown, for example, in FIG. 4C. In some embodiments, first side wall 244 and second side wall 254 can be planar flat surfaces as shown, for example, in FIG. 4D. In some embodiments, first side wall 244 and second side wall 254 can be spaced apart and not transfer loads between first clamp 232 and second clamp 234 as shown, for example, in FIG. 4E.

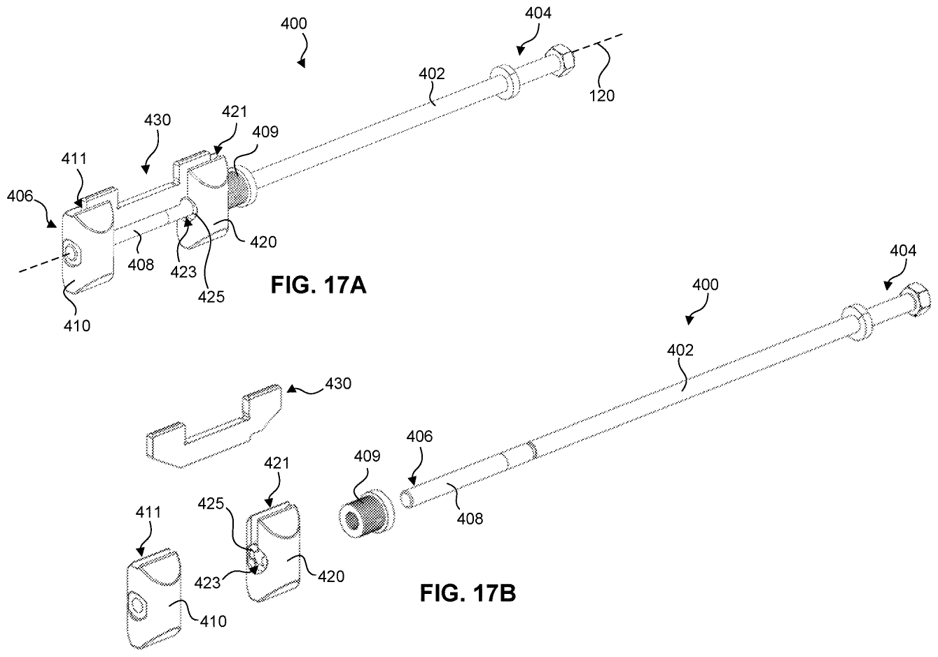

In some embodiments, first clamp 232 and second clamp 234 can be coupled together by a bridge 236 as shown, for example, in FIGS. 5A-5C, 7, 13A-14. In some embodiments, first clamp 232, second clamp 234, and bridge 236 can be a single-piece component that forms a U-shaped clamp. In the illustrative embodiment shown, for example, in FIG. 5A, bridge 236 can taper in a center to provide flexibility such that bridge 236 can bend and first and second clamps 232, 234 can move independently from one another. In some embodiments, bridge 236 can be formed to have different widths as shown, for example, in FIGS. 5B and 5C. For example, bridge 236 can be thinner to provide more flexibility or accommodate components of locking mechanism disposed radially below clamp assembly 230, such as shaft 402 as shown, for example, in FIGS. 17A-21. In some embodiments, bridge 236 can have increased thickness to increase strength of clamp assembly 230 as shown, for example, in FIG. 5C.

In some embodiments, locking mechanism 200 can include retraction and guide features to control movement of clamp assembly 230 in first and second directions 10, 20. For example, in some situations contact members 240, 250 may become stuck when engaged with hitch receiver 14 such that clamp assembly 230 does not move in the second direction 20 when actuators 210, 220 are moved to the unlocked position 60. The retraction features disclosed herein actively move clamp assembly 230 in second direction 20 and out of engagement with hitch receiver 14.

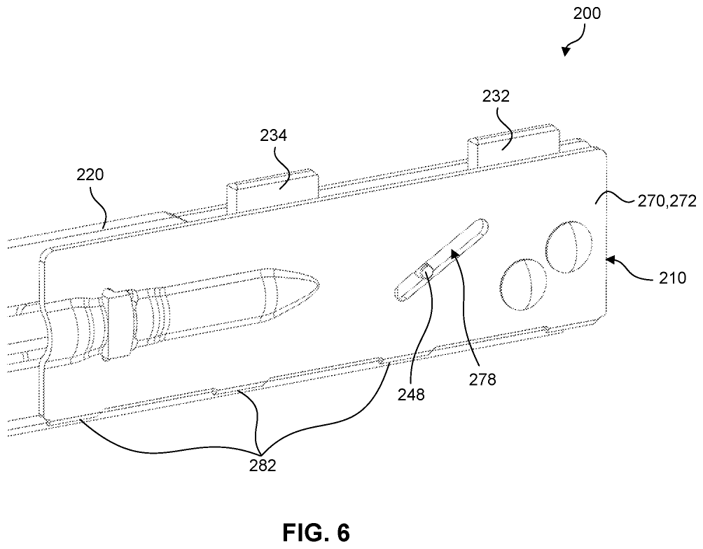

As shown, for example, in FIGS. 2B and 6, first actuator plate 270 can include an actuation slot 278 and first actuator 210 can include a protrusion 248. Protrusion 248 can extend outwardly away from first actuator 210 and into actuation slot 278. Protrusion 248 can move through actuation slot 278 as locking mechanism 200 is moved between locked and unlocked 50, 60 positions. In some embodiments, actuation slot 278 can be angled relative to axis 120 such that when actuation plate 270 moves in the third or fourth directions 30, 40, actuation slot 278 guides protrusion 248 to move first clamp 232 in the first or second directions 10, 20. For example, when actuation plate 270 moves in fourth direction 40, actuation slot 278 guides protrusion 248 along slot 278 such that first clamp 232 moves in second direction 20. In some embodiments, actuation slot 278 and protrusion 248 are spaced apart when actuation plate 270 moves in third direction 30 such that only first actuation surface 212 and first surface 242 move first clamp 232 in first direction 10. In retraction of clamp assembly 230 from hitch receiver 14 (second direction 20), surfaces 212, 242 do not pull or exert a force to move clamp assembly 230 in second direction 20 and actuation slot 278 and protrusion 248 can be operated for this movement.

As shown, for example, in FIGS. 2B, 6, and 10A-C, locking mechanism 200 only includes one actuation slot 278 and one protrusion 248 extending away from first actuator 210. In some embodiments, actuation slot 278 and protrusion 248 operate to move first clamp 232 in second direction 20, and in turn, protrusion 246 in first side wall 244 of first clamp 232 engages recess 256 in second side wall 254 of second clamp 234 to move second clamp 234 in second direction 20.

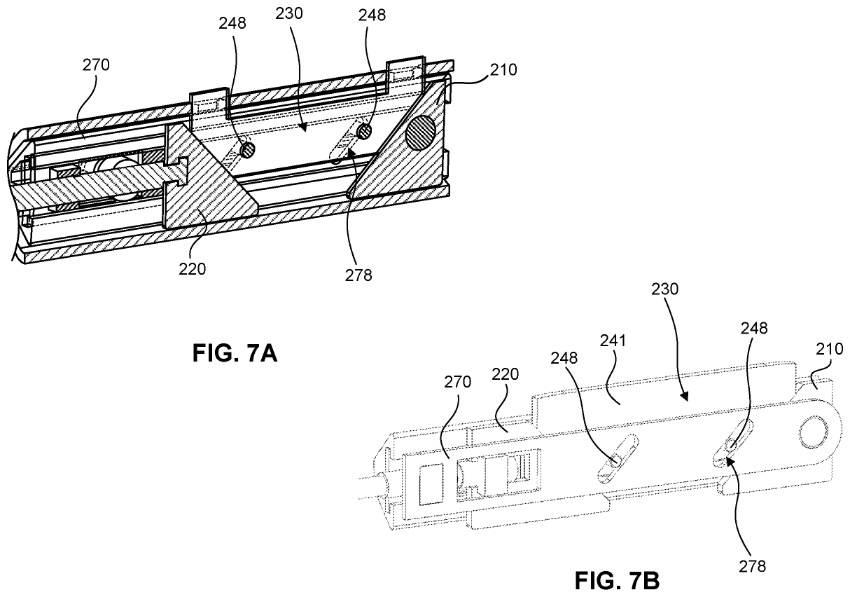

As shown, for example, in the embodiments in FIG. 7A, clamp assembly 230 can include two actuation slots 278 orientated substantially parallel to one another, and actuation plate 270 can include two actuation protrusions 248 that extend into actuation slots 278. As shown, for example, in FIG. 7B, clamp assembly 230 can include two protrusions 248 extending from a single-piece U-shaped clamp 230. In some embodiments, each of first clamp 232 and second clamp 234 can include a protrusion 248 for individual movement of first and second clamps 232, 234. As shown, for example, in FIG. 7B, clamp assembly 230 can include a single continuous contact member 241 that extends along a length of clamp assembly 230

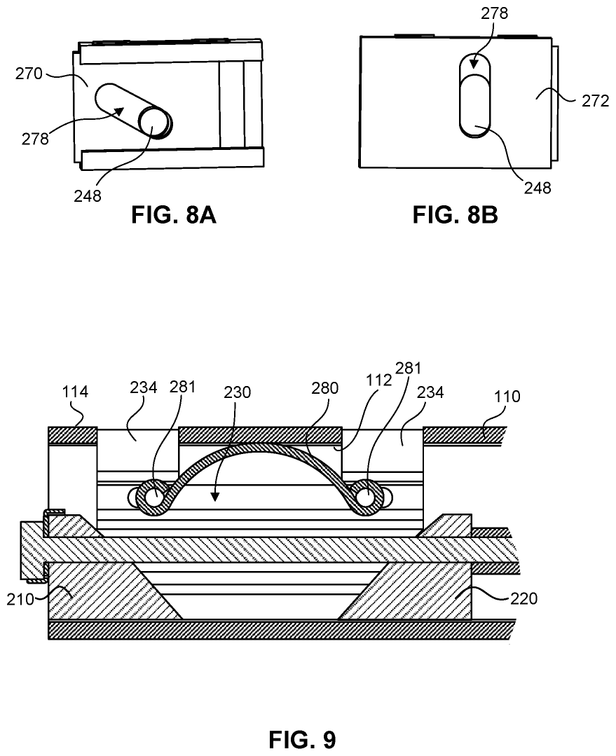

In some embodiments, first actuation plate 270 can include a diagonally oriented actuation slot 278 as shown, for example, in FIG. 8A, and second actuation plate 272 can include an approximately vertical orientated actuation slot 278 as shown, for example in FIG. 8B (or vice versa). In some embodiments, actuators 210, 220 can include a protrusion 248 (e.g., round or pill-shaped) received in an approximately vertical orientated actuation slot 278 of actuation plate 270, 272 to facilitate vertical guidance of clamp 232, 234 in first and second directions 10, 20.

In some embodiments, locking mechanism 200 can include spring 280 as shown, for example, in FIG. 9. In some embodiments, spring 280 can be disposed between clamp assembly 230 and interior surface 112 of connecting member 110. In some embodiments, spring 280 can be configured to bias clamp assembly 230 in second direction 30 and away from engagement with interior surface 16 of hitch receiver 14. In some embodiments, spring 280 can couple to protrusions 281 that extend away from clamp assembly 230. In some embodiments, spring 280 can contact a flat surface on clamp assembly 230.

In some embodiments, locking mechanism 200 can include stop member 205 disposed along shaft 202 to facilitate retraction of clamp assembly 230 in second direction 20 as shown, for example in FIGS. 10A-10C. Interaction between shaft 202, stop member 205, a stop plate 150, fastener flange 274, second actuator 220, actuator plate 270, 272, first actuator 210, actuation slot 278, and/or protrusion 248 facilitate active movement of clamp assembly 230 in second direction 20 as shown, for example, in FIGS. 10A-10C. For example, shaft 202 can be rotated to loosen locking mechanism 200 and the threaded engagement between shaft 202 and fastener flange 274 can move shaft 202 and second actuator 220 in third direction 30, away from clamp assembly 230 and first actuator 210. As shaft 202 moves in third direction 30, stop member 205 approaches and engages stop plate 150. As shown, for example, in FIGS. 10A and 10B, stop member 205 moves toward and engages stop plate 150 during this initial stage.

When stop member 205 engages stop plate 150, shaft 202 is prevented from further axial movement in third direction 30. Continued rotation of shaft 202 can translate fastener flange 274 in the fourth direction 40 along threaded portion 208 toward second end 206 of shaft 202. As shown, for example, in FIGS. 10A-10C, distance 290 between retaining slot 226 and fastener flange 274 decreases throughout the operation.

Translation of fastener flange 274 in fourth direction 40 moves actuation plates 270, 272 and first actuator 210 in fourth direction 40 and away from second actuator 220. Translation of first actuator 210 in fourth direction 40 moves actuation protrusion 248 in actuation slot 278, subsequently driving first actuator 210 in second direction 20 as shown, for example, in FIGS. 6 and 10C. Protrusion 246 of first clamp 232 can engage with recess 256 of second clamp 234 such that first clamp 232 moves second clamp 234 in second direction 20. Continued rotation of shaft 202 can continue the movement and interactions of stop member 205, stop plate 150, fastener flange 274, shaft 202, actuators 210, 220, actuator plates 270, 272, protrusion 248, actuation slot 278, and clamp assembly 230 described above and shown, for example, in FIGS. 10B and 10C. Movement and interaction of locking mechanism 200 can continue until both clamp contact members 240, 250 of clamp assembly 230 are disengaged and spaced apart from interior surface 16 of hitch receiver 14 in unlocked position 60 such that, for example, load carrier 100 can be removed from hitch receiver 14 and vehicle 12.

As shown, for example, in FIG. 11, locking mechanism 200 can be arranged diagonally in interior 116 of connecting member 110 extending between opposite corners 118, 119. In some embodiments, first and second aperture 130, 132 of connecting member 110 can extend through a corner 118 of connecting member 110. Locking mechanism 200 can include rod 284 disposed in second corner 119 between actuation plates 270, 272 as shown, for example, in FIGS. 2B and 11. In some embodiments, rod 284 is disposed opposite clamp assembly 230. In some embodiments, rod 284 fills a space between first and second actuators 210, 220 and interior surface 112 at second corner 119 of connecting member 110. In some embodiments, first and second actuators 210, 220 can push against rod 284 when clamp assembly 230 is under load from contact with hitch receiver 14. In some embodiments, rod 284 provides a glide surface for first and second actuators 210, 220 to slide on in third and fourth directions 30, 40. In some embodiments, actuator plates 270, 272 can include chamfer surfaces 282 as shown, for example, in FIGS. 2B, 6, and 11. In some embodiments, chamfer surfaces 282 extend approximately perpendicular to interior surface 112 adjacent to second corner 119. In some embodiments, chamfer surfaces 282 can reduce damage to interior surface 112 of connecting member 110 during operation of load carrier 100. In some embodiments, chamfers 282 can center locking mechanism 200 in interior 116 of connecting member 110 and increase stability of the assembly.

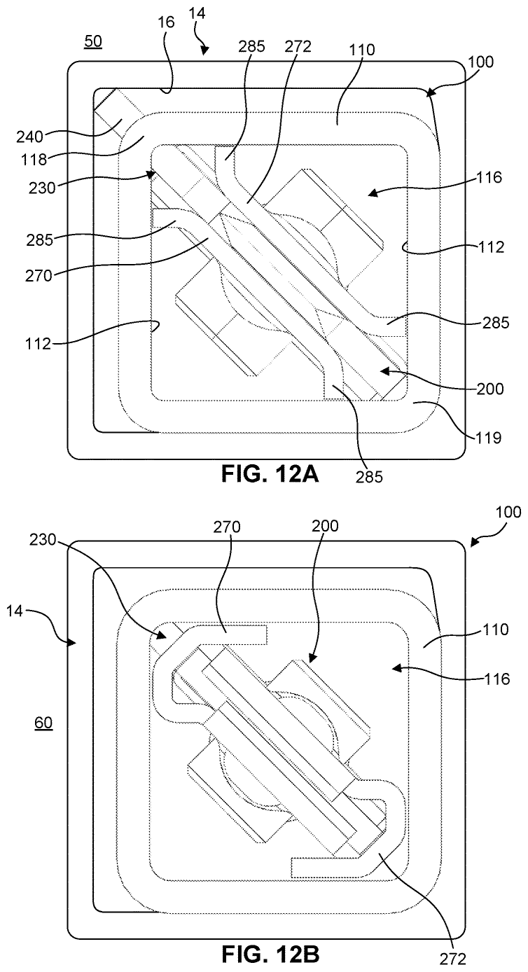

As shown, for example, in FIG. 12A, actuator plates 270, 272 can include flared edge portions 285 that extend outwardly from actuator plates 270, 272 and are approximately perpendicular to adjacent interior surfaces 112 of connecting member 110. In the illustrative embodiment shown, for example, in FIG. 12B, actuator plates 270, 272 wrap around top and bottom portions of locking mechanism 200. In some embodiments, actuator plates 270, 272 support locking mechanism 200 in interior 116 of connecting member 110. In some embodiments, actuation member 270, 272 approximately center locking mechanism 200 in interior 116 of connecting member 110.

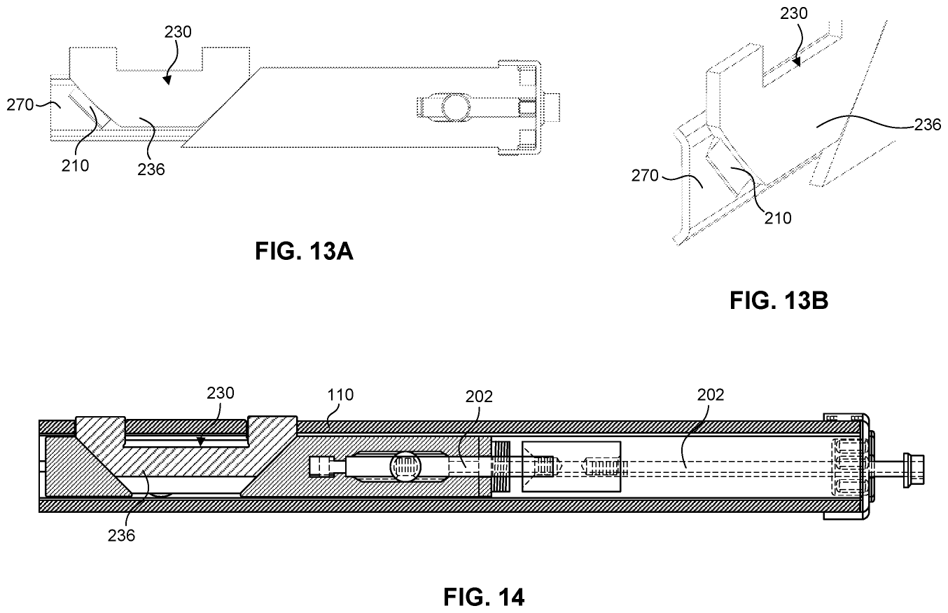

In some embodiments, first actuator 210 protrudes away from actuator plate 270 as shown, for example, in FIGS. 13A and 13B. In some embodiments, first actuator 210 and actuator plate 270 are a single-piece integral component. In some embodiments, actuator plate 270 can be made from sheet metal, and first actuator 210 can be formed by bending a portion of actuator plate 270 toward a center of locking mechanism 200. In the illustrative embodiment shown, for example, in FIG. 14, clamp assembly 230 includes a thick bridge 236 and is overlapped by one actuator plate 270. In some embodiments, shaft 202 can include multiple shorter rotating elements with coupling pieces to join them together to extend along the length of connecting member 110.

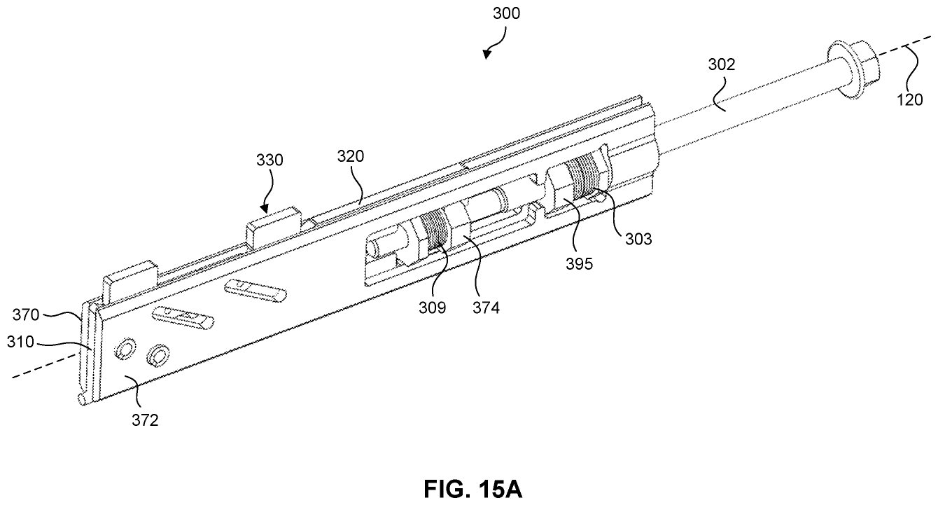

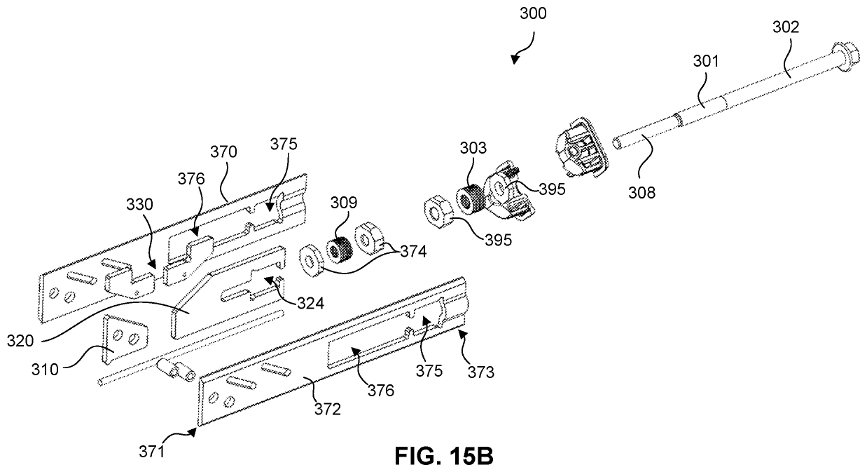

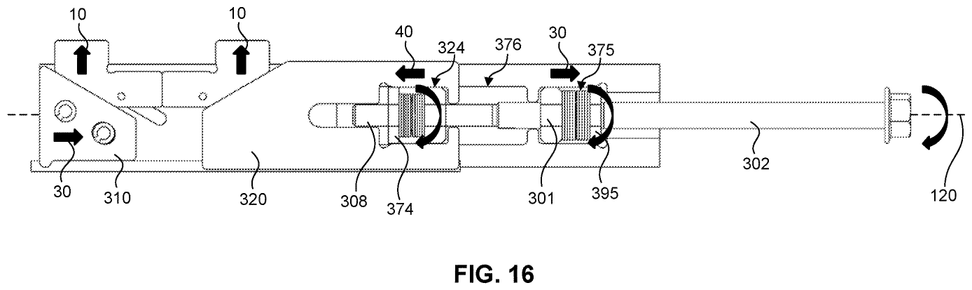

Referring to FIGS. 15A-16, locking mechanism 300 is shown. Locking mechanism 300 is configured to be used in load carrier 100 and is substantially similar to locking mechanism 200 shown in, for example, FIGS. 2A, 2B, and 11. Accordingly, similar reference numbers in the 300 series indicate features that are common between the locking mechanism 200 and locking mechanism 300. The description of the locking mechanism 200 and its assembly are hereby incorporated by reference to apply to the locking mechanism 300, except in instances when it conflicts with the specific description and drawings of the locking mechanism 300.

Locking mechanism 300 can include shaft 302, first actuator 310, second actuator 320, clamp assembly 330, first actuator plate 370, and/or second actuator plate 372 as shown, for example, in FIGS. 15A and 15B. In some embodiments, shaft 302 can be rotated, which linearly translates first actuator 310 and second actuator 320 along axis 120. Shaft 302 can extend along axis 120 and be coupled to second actuator 320 and first actuator 310, for example, via actuation plates 370, 372. Shaft 302 can include a first end 304, a second end 306, a first threaded portion 301, and second threaded portion 308.

Shaft 302 can be threadably coupled to a first fastener flange 395 along first threaded portion 301 and threadably coupled to a second fastener flange 374 along second threaded portion 308. Shaft 302 can be configured to be axially fixed relative to connecting member 110 such that shaft 302 does not move in the third or fourth directions 30, 40. First threaded portion 301 can have a first direction thread, for example, clockwise, and second threaded portion 308 can have a second direction thread, for example, counter-clockwise. Accordingly, when shaft 302 is rotated, first threaded portion 301 translates first fastener flange 395 in third direction 30 and second threaded portion 308 translates second fastener flange 374 in fourth direction 40 opposite third direction 30 as shown, for example, in FIG. 16. In some embodiments, shaft 302 can be rotated in the opposite direction such that first fastener flange 395 is translated in fourth direction 40 and second fastener flange 374 is translated in third direction 30.

In some embodiments, second actuator 320 can include a second actuation surface 322 and an elongated aperture 324 as shown, for example, in FIGS. 15B and 16. Elongated aperture 324 can be formed in second actuator 320 along axis 120. Elongated aperture 324 can be sized to accommodate second fastener flange 374. Second fastener flange 374 can be configured to engage with forward and rearward surfaces of elongated aperture 224 to transfer forces and movement of second fastener flange 374 to second actuator 320.

In some embodiments, first actuator 310 can be coupled to first actuator plate 370 and second actuator plate 372 as shown, for example, in FIGS. 15A-16. First actuator plate 370 and second actuator plate 372 can be the same or substantially similar and include a first end 371, a second end 373 opposite first end 371, a translation slot 375, and/or an elongated recess 376 as shown, for example, in FIGS. 15A-16. Elongated recess 276 can be formed in actuation plates 370, 372 and configured to accommodate shaft 302, second threaded portion 308, and second fastener flange 374. A length of elongated recess 376 can be sized to accommodate relative movements of second fastener flange 374 and actuation plates 370, 372 when locking mechanism 300 is moved between the locked position 50 and unlocked position 60.

Translation slot 375 can be formed through actuation plates 370, 372 rearward of elongated recess 376 as shown, for example, in FIGS. 15A-16. Translation slot 375 can be configured to receive first fastener flange 295. In some embodiments, first fastener flange 395 can be configured to engage with forward and rearward surfaces of translation slot 375 such that movement of first fastener flange 395 is transferred into actuator plates 370, 372.

In some embodiments, locking mechanism 300 can include first spring 303 and/or second spring 309 as shown, for example, in FIGS. 15A-16. First spring 303 can be disposed between first fastener flange 395 and actuator plates 370, 372. Second spring 309 can be disposed between second fastener flange 374 and second actuator 220. First and second springs 303, 309 can couple to shaft 202 and exert a force on second actuator 320 and first actuator 310 via actuator plates 370, 372 to limit torque-loss in locking mechanism 300.

Interaction between first fastener flange 395, second fastener flange 374, shaft 302, second actuator 320, and actuator plate 370, 372 facilitates opposite movements of second actuator 320 relative to first actuator 310 in third and fourth directions 30, 40 as shown, for example, in FIG. 16. For example, shaft 302 can be rotated and the threaded engagement between second fastener flange 374 along second threaded portion 308 can move second fastener flange 274 along shaft to move second actuator 320 in fourth direction 40. Similarly, first fastener flange 395 can translate along first threaded portion 301 when shaft 302 is rotated to move actuator plates 370, 372 and first actuator 310 in third direction 30 opposite fourth direction 40. Movement and interaction of locking mechanism 300 can continue until both clamp contact members 340, 350 of clamp assembly 330 engage with hitch receiver 14 in locked position 50 and form the desired friction-fit between locking mechanism 300 and hitch receiver 14.

Referring to FIGS. 17A-20, locking mechanism 400 is shown. Locking mechanism 400 is configured to be used in load carrier 100 and is substantially similar to locking mechanism 200 shown in FIGS. 2A, 2B, and 11. Accordingly, similar reference numbers in the 400 series indicate features that are common between the locking mechanism 200 and locking mechanism 400. The description of the locking mechanism 200 and its assembly are hereby incorporated by reference to apply to the locking mechanism 400, except in instances when it conflicts with the specific description and drawings of the locking mechanism 400.

Locking mechanism 400 can include a shaft 402, a first actuator 410, a second actuator, 420, and/or clamp assembly 430 as shown, for example, in FIGS. 17A-20. In some embodiments, shaft 402 can be rotated, which linearly translates first actuator 410 towards second actuator 420 along axis 120. Shaft 402 can extend along axis 120 through an aperture 423 in second actuator 420 and couple to first actuator 410. Shaft 402 can include a first end 404, a second end 406, a threaded portion 408 disposed at the first end 404, and/or a spring 409. Shaft 402 can threadably couple with first actuator 410 at second end 406 such that rotation of shaft 402 moves first actuator 410 in the third direction 30 or the fourth direction 40 depending on the direction of rotation of shaft 402.

Spring 409 can couple to shaft 402 and exert a force on second actuator 420 to limit torque-loss in locking mechanism 400. In the illustrative embodiment shown, for example, in FIG. 17B, spring 409 can be fixed to shaft 402. In some embodiments, spring 409 can engage second actuator 420 and exert a force on second actuator in fourth direction 40.

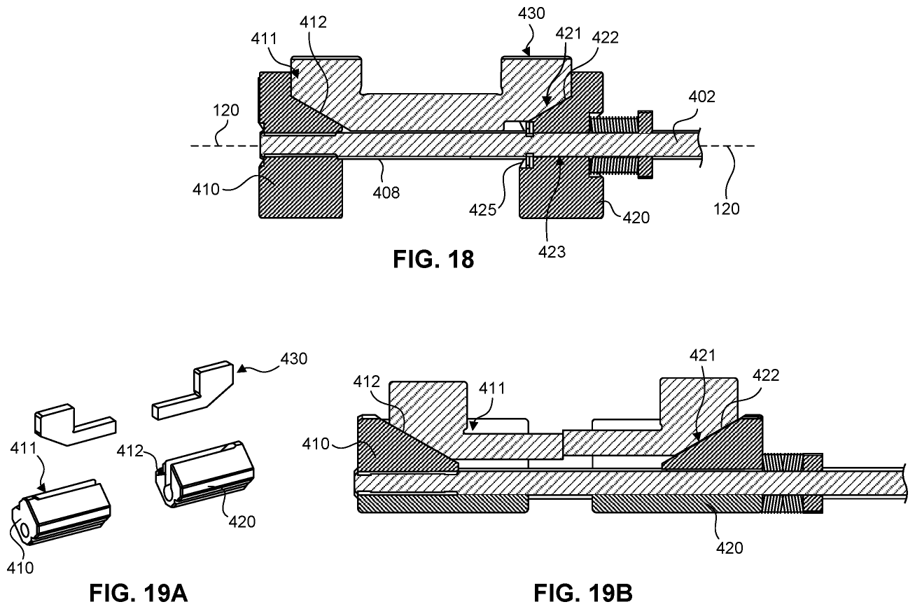

Second actuator 420 can include a slot 421, second actuation surface 422, and/or aperture 423 as shown, for example, in FIGS. 17A-18. In some embodiments, slot 421 can be formed through second actuator 420. In some embodiments, slot 421 can be configured to receive clamp assembly 430. In some embodiments, second actuation surface 422 can be disposed in slot 421. In some embodiments, second actuation surface 422 can be an angled surface relative to axis 120 and can be configured to engage a second surface 452 of clamp assembly 430. Second actuation surface 422 can be configured to transfer axial movement of second actuator 420 along axis 120 into radial movement of clamp assembly 430 in the first and/or second directions 10, 20. In some embodiments, a circlip 425 can be fixed to shaft 202 adjacent to aperture 423 such that when shaft 402 is rotated to move locking mechanism 400 into unlocked position 60, circlip 425 can translate second actuator 420 in third direction 30 away from first actuator 410.

In some embodiments, first actuator 410 is configured to translate in the third and/or fourth directions 30, 40 and cause clamp assembly 430 to translate in first and second direction 10, 20 to engage and disengage with hitch receiver 14. First actuator 410 can be disposed opposite second actuator 420, so that a first actuation surface 412 of first actuator 410 faces toward second actuation surface 422 of second actuator 420 as shown, for example, in FIG. 18. First actuator 410 can include a slot 411 and first actuation surface 412 as shown, for example, in FIGS. 17A-18. In some embodiments, slot 411 can be formed through first actuator 410. In some embodiments, slot 411 can be configured to receive clamp assembly 430. In some embodiments, first actuation surface 412 can be disposed in slot 411. In some embodiments, first actuation surface 412 can be an angled surface relative to axis 120 and can be configured to engage a first surface 442 of clamp assembly 430. First actuation surface 412 can be configured to transfer axial movement of first actuator 410 along axis 120 into radial movement of clamp assembly 430 in the first and/or second directions 10, 20.

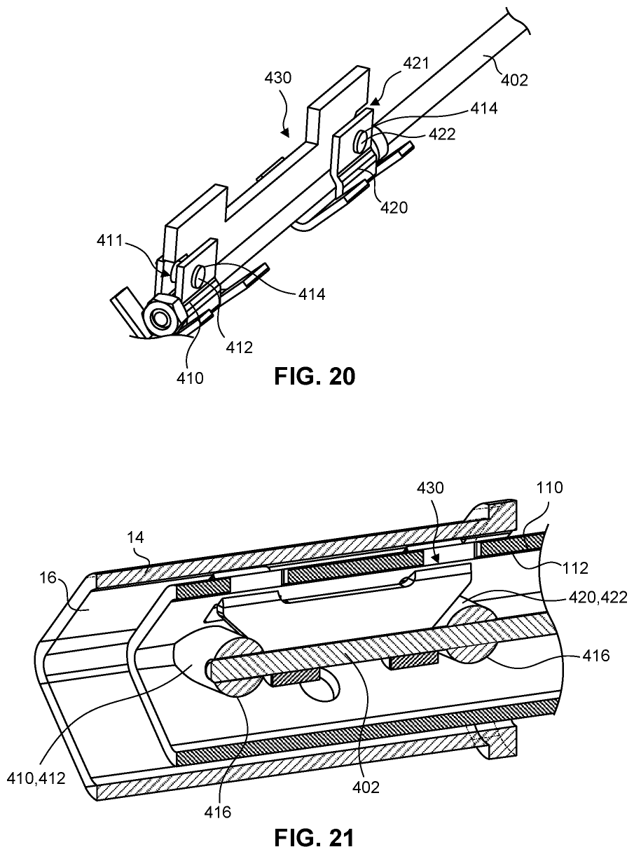

As shown, for example, in FIGS. 19A and 19B, first and second actuators 410, 420 include elongated slots 411, 421 that extend beneath a substantial portion of clamp assembly 430. Elongated slots 411, 421 can guide and support clamp assembly 430 and free up volume of connecting member 410 below shaft 402. In the illustrative embodiment shown, for example, in FIG. 20, locking mechanism 400 is made using an assembly of plates. In some embodiments, actuation surfaces 412, 422 can be fasteners 414 that extend through the plate assembly to couple adjacent sides together that form slots 411, 421.

As shown, for example, in FIG. 21, first and second actuators 410, 420 can be cylinders that rotatably couple to interior surface 112 of connecting member 110. The external perimeter surface of the rollers can form actuation surfaces 412, 422 to move clamp assembly 430 in first and second directions 10, 20.

In some embodiments, connecting member 110 can include end cap 140 disposed at an end of connecting member 110 as shown, for example, in FIGS. 2A, 2B, 22, and 23. End cap 140 can be configured to prevent debris from entering connecting member 110 and to support, guide, and/or center first end 204 of shaft 202. In some embodiments, end cap 140 can be an injection molded component formed from a plastic or other similar materials. End cap 140 can include stop plate 150 extending through end cap 140. Stop plate 150 can be made of a rigid material, for example, metals (e.g., steel, stainless steel, iron, aluminum, tungsten, lead, titanium, etc.), metal oxides, ceramics, polymers, or other similar rigid materials. As described above, stop plate 150 can be configured to engage stop member 205 of shaft 202 during retraction of clamp assembly 230. Stop plate 150 has increased strength and stiffness over end cap 140 such that stop plate 150 can accommodate larger loads from locking mechanism 200. In some embodiments, stop plate 150 extends through slots 145 formed in end cap 140. In some embodiments, stop plate 150 can include a locking plate 155 that extends approximately perpendicular to stop plate 150 on an exterior surface 114 of connecting member 110. In some embodiments, locking plate 155 can be configured to secure handle 600 to connecting member 110 when handle 600 is in a storage configuration.

### Example Securement Pin Assembly

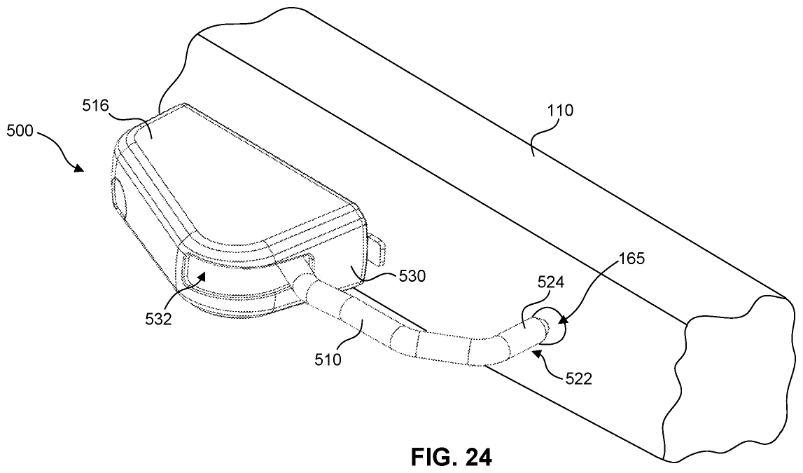

FIGS. 24-27C illustrate a securement pin assembly 500, according to embodiments. Securement pin assembly 500 can be configured to secure load carrier 100 to hitch 14. Although securement pin assembly 500 is shown in FIGS. 24-27C as a stand-alone system coupled to load carrier 100, the embodiments of this disclosure can be used with other apparatuses and/or systems, such as, but not limited to locking mechanisms 200, 300, 400 and handle assembly 600.

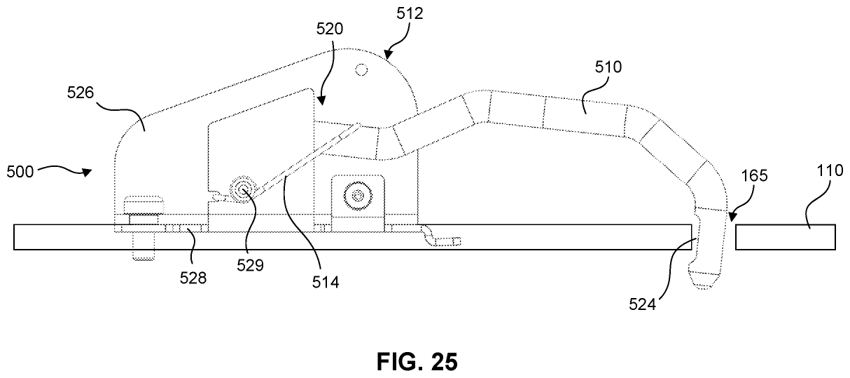

Securement pin assembly 500 can be coupled to connecting member 110 as shown, for example, in FIG. 1. Securement pin assembly 500 can include a pin body 510 with a free end 522 configured to be inserted through an aperture 165 in connecting member 110 and an aperture 25 in hitch receiver 14. As shown in the illustrative embodiment of FIGS. 24 and 25, securement bar assembly 500 can include a self-locating pin body 510 for securing the securement bar assembly 500 of load carrier 100 to hitch receiver 14 of a vehicle 12. In some embodiments the pin body can be made of flexible or inflexible materials.

In some embodiments, securement pin assembly 500 can include pin body 510, load bracket 512, spring 514, and/or housing 516 as shown, for example, in FIGS. 24 and 25. Securement pin assembly 500 can be coupled to connecting member 110. Connecting member 110 can include an insertable end 160 configured to be inserted into hitch receiver 14. Connecting member 110 can include aperture 165 that extends through connecting member 110 and is configured to receive pin body 510 of securement pin assembly 500. In some embodiments, when a desired length of connecting member 110 is inserted into hitch receiver 14, an aperture 25 of hitch receiver 14 can be aligned with aperture 165 of connecting member 110. Pin body 510 can be configured to be inserted through aligned apertures 25, 165.

Securement pin assembly 500 can be coupled to the connecting member 110 at a fixed distance from a free end 522 of pin body 510 that accommodates or enables repetitive, same location positioning of the free end 522 of pin body 510. Free end 522 can include a hook 524 that is configured to be inserted into aligned apertures 25, 165. Pin body 510 can be biased toward the connecting member 110 via spring 514 such that free end 522 can automatically insert into apertures 25, 165. Load carrier 100 can be coupled to hitch 14 when hook 524 of the pin body 510 is received by apertures 25, 165 in hitch 14 and connecting member 110.

In some embodiments, pin body 510 can include a fixed end 520 rotatably coupled to bracket 512, and free end 522 configured to be inserted into and secured with hitch receiver 14. In some embodiments, pin body 510 can be a non-linear elongated body that extends from the fixed end 520 to the free end 522. In some embodiments, pin body 510 can be shaped to provide clearance to any flanges or protruding features extending from hitch receiver 14. In some embodiments, pin body 510 can be made from a bent metal bar. In some embodiments, free end 522 can be orientated approximately perpendicular to connecting member 110. Free end 522 can include hook 524 that can be configured secure free end 522 of pin body 510 in aperture 25 of hitch receiver 14.

Bracket 512 can couple to connecting member 110 and pin body 510 as shown, for example, in FIG. 25. Bracket 512 can include top plate 526 and mounting plate 528. In some embodiments, mounting plate 528 can fixedly couple to connecting member 110 to couple securement pin assembly 500 to load carrier 100. In some embodiments, bracket 512 can be configured to transfer loads from pin body 510 into connecting member 110. For example, a user can lift load carrier 100 using pin body 510 as a handle, and the lifting load of load carrier 100 can be transferred from pin body 510 through bracket 512 and into connecting member 110. In some embodiments, top plate 526 can extend above pin body 510 approximately perpendicular to mounting plate 528. In some embodiments, top plate 526 covers a portion of pin body 510. In some embodiments, pin body 510 engages top plate 526 to transfer loads from pin body 510 when pin body 510 is used as a handle for load carrier 100. In some embodiments, bracket 512 can include a bottom plate substantially similar to top plate 526 but extending below pin body 510.

As shown, for example, in FIG. 25, pin body 510 is coupled to bracket 512 at an attachment point 529. Pin body 510 can be rotatably coupled at attachment point 529 such that pin body 510 pivots about attachment point 529. In some embodiments, attachment point 529 is disposed at a fixed distance from free end 522 of pin body 510 and a front face 530 of housing 516 such that when pin body 510 is inserted into hitch 14, housing 516 is spaced apart from hitch 14.

In some embodiments, spring 514 is coupled between pin body 510 and bracket 512 and configured to bias free end 522 of pin body 510 toward connecting member 110 and hitch 14. In some embodiments, spring 514 is coupled to bracket 512 at attachment point 529. Spring 514 can be a torsional spring, a leaf spring, a linear spring, or another suitable biasing member. Housing 516 is configured to cover bracket 512 and spring 514, and at least a portion of pin body 510 as shown, for example, in FIG. 24. Housing 516 can include front face 530 and an aperture 532 formed in front face 530. Pin body 510 can be configured to extend through and move within aperture 532. In some embodiments, securement pin assembly 500 can automatically move between a loading position and a locked position when connecting member 110 is inserted a fixed distance into hitch receiver 14.

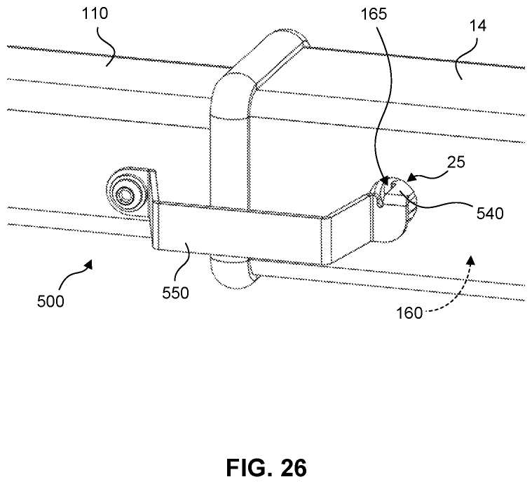

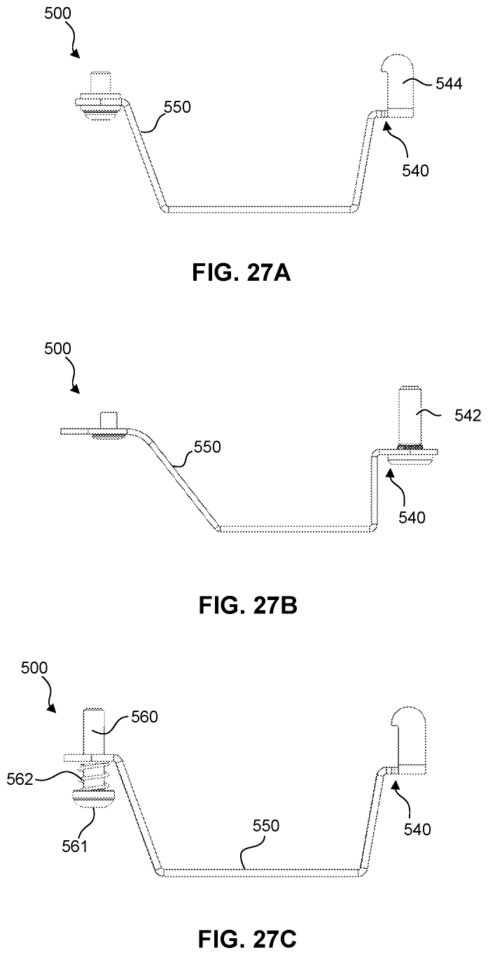

As shown, for example, in FIGS. 26-27C, securement pin assembly 500 can include plate pin body 550. In some embodiments, plate pin body 550 can be made from bent metal plate, sheet metal, or other similar flat materials. Plate pin body 550 can couple to connecting member 110 and extend into apertures 25, 165 of hitch receiver 14 and connecting member 110. In some embodiments, plate pin body 550 can be rotatably coupled to connecting member 110 such that plate pin body 550 can be rotated into a loading configuration where an insertion end 540 of plate pin body 550 extends below and is spaced apart connecting member 110 and hitch receiver 14. In some embodiments, plate pin body 550 can be configured to bend and/or deflect to move insertion end 540 into and out of apertures 25, 165.

As shown in the illustrative embodiment of FIG. 27A, insertion end 540 can include a pin 544 that extends approximately perpendicular to insertion end 540. In some embodiments, pin 544 is integral with plate pin body 550 and is bent relative to insertion end 540 to be orientated toward connecting member 110. In some embodiments, pin 544 can include a hook shape. As shown in FIG. 27B, insertion end 540 of plate pin body 550 can include a bolt 542 that extends approximately perpendicular to insertion end 540 and toward connecting member 110. In some embodiments, bolt 542 can be coupled to insertion end 540 with a nut, by adhesion, by welding, or other suitable coupling methods.

As shown in the illustrative embodiment of FIG. 27C, plate pin body 550 can be coupled to connecting member 110 with elongated fastener 560. In some embodiments, plate pin body 550 can include a spring 562 disposed between a head 561 of elongated fastener 560 and plate pin body 550. In some embodiments, plate pin body 550 is configured to translate along elongated fastener 560 such that insertion end 540 translates into and out of apertures 25, 165 of hitch receiver 14 and connecting member 110. In some embodiments, plate pin body 550 can be configured to translate and bend to move insertion end 540 into and out of apertures 25, 165. In some embodiments, spring 562 can be configured to bias plate pin body 550 towards connecting member 110 and insertion end 540 into apertures 25, 165.

### Example Handle Assembly

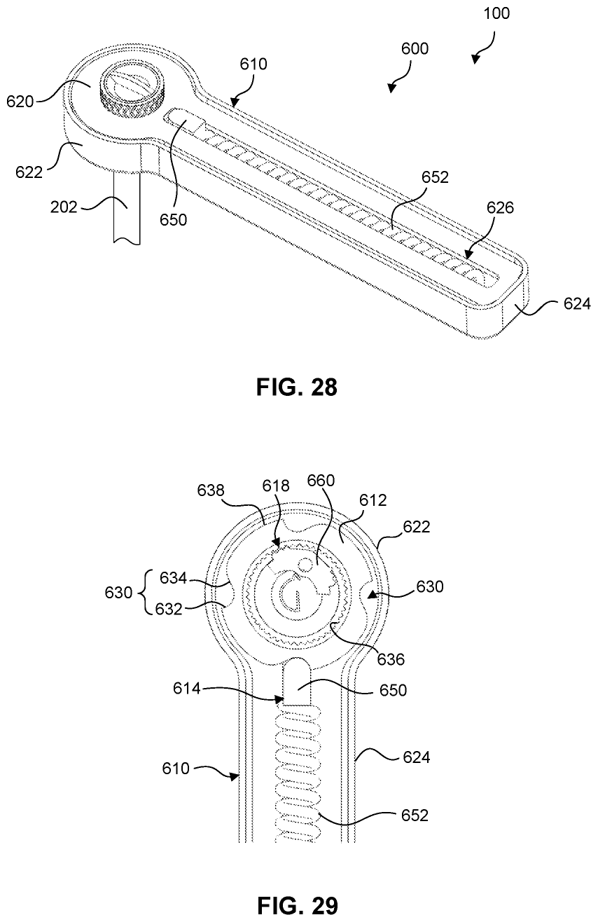

FIGS. 28-31 illustrate a handle assembly 600, according to embodiments. Handle assembly 600 can be configured to limit a torque applied to shaft 202. Although handle assembly 600 is shown in FIGS. 28-31 as a stand-alone system coupled to load carrier 100, the embodiments of this disclosure can be used with other apparatuses and/or systems, such as, but not limited to locking mechanism 200, 300, 400 and securement pin assembly 500.

Handle assembly 600 can couple to shaft 202 and be configured rotate shaft 202 to operate locking mechanism 200, 300, 400. Handle assembly 600 can include handle body 610, control ring 612, first torque arm 614, and/or ratchet mechanism 618 as shown, for example, in FIGS. 28 and 29. Control ring 612 can be coupled to shaft 202 via ratchet mechanism 618 and configured to rotate with shaft 202. First torque arm 614 can be movably coupled to handle body 610 and configured to move with handle body 610.

In some embodiments, first torque arm 614 can be releasably engaged with control ring 612 such that when first torque arm 614 engages control ring 612, handle body 610 rotates shaft 202, and when first torque arm 614 disengages from control ring 612, handle body 610 rotates independently from shaft 202. Engagement of first torque arm 614 and control ring 612 can be torque limited such that when a first torque is applied to handle body 610 that is below the limit torque, first torque arm 614 remains in engagement with control ring 612, and when a second torque, greater than the first torque and exceeding the limit torque, is applied to handle body 610, first torque arm 614 disengages from control ring 612. This can be beneficial to avoid over torquing shaft 202 and causing damage in shaft 202 or a mechanism attached to shaft 202.

In some embodiments, the limit torque is between 5 newton-meters and 50 newton-meters. In some embodiments, the limit torque is between 10 newton-meters and 25 newton-meters. In some embodiments, the limit torque is approximately 15 newton-meters. In some embodiments, the limit torque is approximately 20 newton-meters.

In some embodiments, handle body 610 can include a cover plate 620, a mechanism housing 622, and/or a lever 624 extending away from mechanism housing 622, as shown for example, in FIGS. 28 and 29. Cover plate 620 can extend over mechanism housing 622 and lever 624 to cover the internal components of handle assembly 600. In some embodiments, mechanism housing 622 can be approximately concentric with shaft 202. In some embodiments, lever 624 can extend radially outward from mechanism housing 622. Lever 624 can be configured to be gripped by a user such the user can apply a rotational force on handle assembly 600. In some embodiments, lever 624 can be a knob or grooved handle. In some embodiments, lever 624 can be substituted with a tool such as a wrench. In some embodiments, a slot 626 can be formed in cover plate 620 and can extend in the direction of lever 624.

In some embodiments, control ring 612 can be disposed in mechanism housing 622 and configured to rotate with shaft 202. Control ring 612 can include a recess 630 disposed in an outer perimeter 638 of control ring 612, and a plurality of teeth 636 disposed around an inner perimeter of control ring 612 as shown, for example in FIG. 29. Plurality of teeth 636 can be configured to engage with ratchet mechanism 618. Recess 630 can be configured to receive a protruding end 650 of first torque arm 614. Recess 630 can have a shape to limit a torque that can be applied to shaft 202. In some embodiments, control ring 612 can include a plurality of recesses 630 disposed around outer perimeter 638 of control ring 612. In some embodiments, recesses 630 can be equally spaced around control ring 612. In some embodiments recesses 630 can be formed in pairs on opposite sides of control ring 612.

In some embodiments, recess 630 can have an arc with compound radii such that a first portion 632 of recess 630 can limit torque in a first direction, and a second portion 634 can allow free rotation of handle body 610 relative to shaft 202 in a second direction opposite first direction. For example, a first portion 632 of recess 630 can be approximately perpendicular to the outer perimeter 638 of control ring 612 such that at least the limit torque is needed for protruding end 650 to slip over first portion 632 to disengage first torque arm 614 from control ring 612. In some embodiments, first portion 632 of recess 630 can have an angle or blended radius with outer perimeter 638 of control ring 612 such that the limit torque is lowered for protruding end 650 to slip over recess 630. In some embodiments, when first torque is applied to handle body 610 that is below the limit torque, the shape of first portion 632 of recess 630 can retain protruding end 650 in recess 630. In some embodiments, second portion 634 of recess 630 can extend toward outer perimeter 638 of control ring 612 with a shallow angle or large radii that blends with the outer perimeter 638. In some embodiments, only a third torque, lower that the first torque and limit torque, is needed for protruding end 650 to slip over second portion 634 to disengage first torque arm 614 from control ring 612.

In some embodiments, first torque arm 614 can be movably coupled to handle body 610 and translate relative to handle body 610 into and out of engagement with control ring 612. First torque arm 614 can include a protruding end 650 and a spring 652 configured to bias protruding end 650 toward control ring 612 as shown, for example, in FIGS. 28 and 29. First torque arm 614 can be configured to engage with control ring 612 to prevent relative rotation between control ring 612 and handle body 610 when a first torque is applied to handle body 610 less than the limit torque. First torque arm 614 can be configured to slip over recesses 630 in control ring 612 to allow relative rotation between control ring 612 and handle body 610 when a second torque is applied to handle body 610 greater than the limit torque. In some embodiments, protruding end 650 can be received in slot 626 of cover plate 620. In some embodiments, slot 626 can be configured to linearly guide protruding end 650 toward and away from control ring 612. In some embodiments, spring 652 can be coupled between handle body 610 and protruding end 650 such that protruding end 650 can be biased toward control ring 612. In some embodiments, spring 652 can extend along lever 624 and be visible along an elongated length of slot 626. In some embodiments, a spring force of spring 652 can be adjusted to adjust the limit torque for handle assembly 600. For example, spring 652 can be compressed by a set screw, coupled to handle body 610, increasing the spring force of spring 652 and the force applied to protruding end 650 in recess 630. Increasing the spring force of spring 652 can require more torque to disengage protruding end 650 from recess 630.

Ratchet mechanism 618 can be disposed in mechanism housing 622 and rotatably coupled with shaft 202 and control ring 612 as shown, for example, in FIG. 29. Ratchet mechanism 618 can be configured to control rotation of handle body 610 relative to shaft 202 to improve user operability of handle assembly 600. Ratchet mechanism 618 can include rocker 660 that engages plurality of teeth 636 of control ring 612. In some embodiments, rocker 660 can be rotated between clockwise and counter-clockwise configurations to allow teeth 636 to slip over rocker 660 in a first direction and engage with rocker 660 in a second direction, or for teeth 636 slip over rocker 660 in the second direction and engage with rocker 660 in the first direction.

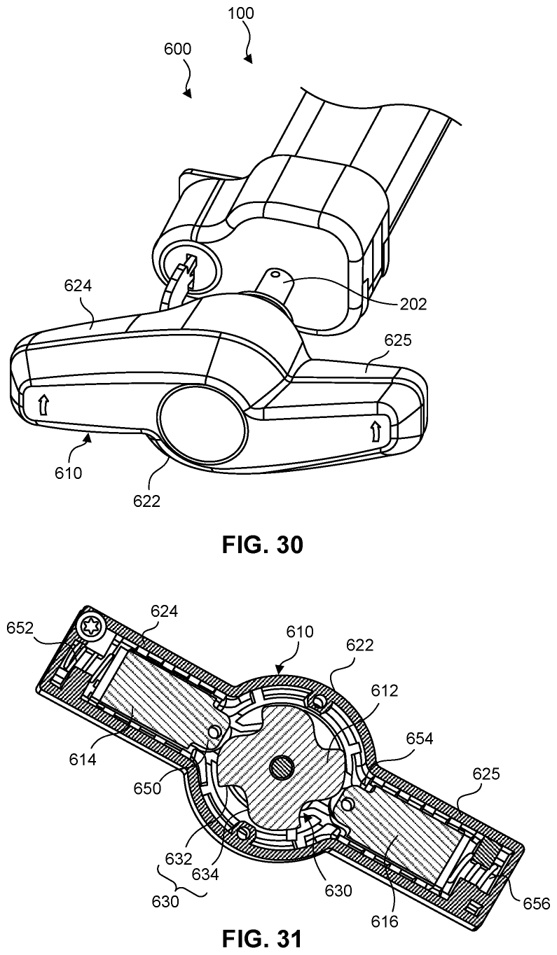

In some embodiments, handle assembly 600 can include first torque arm 614 and/or second torque arm 616 as shown, for example, in FIGS. 30 and 31. As shown in the illustrative embodiment of FIGS. 30 and 31, handle body can include first lever 624 and second lever 625 extending away from mechanism housing 622 in an opposite direction to first lever 624. In some embodiments, each torque arm 614, 616 extends into each respective lever 624, 625. In some embodiments, handle assembly 600 can include more than two levers and two torque arms.

Second torque arm 616 can be substantially similar to first torque arm 614 as shown, for example, in FIG. 31. It may be beneficial for handle assembly 600 to have two or more torque arms 614, 616 to increase the torque limit such that great torque can be applied to handle assembly 600 before torque arms 614, 616 slip over recesses 630 in control ring 612. In some embodiments, recesses 630 are disposed on opposite sides of control ring 612 such that first and second torque arms 614, 616 are disposed in recesses 630 simultaneously. In some embodiments, recesses 630 are not disposed on opposite sides of control ring 612 such that only one of first torque arm 614 and second torque arm 616 are disposed in recesses 630 at any one time, and frequency of engagement between torque arms 614, 616 and control ring 612 is increased.

In some embodiments, second torque arm 616 can be movably coupled to lever 625 of handle body 610 and translate relative to handle body 610 into and out of engagement with control ring 612. Second torque arm 616 can include a protruding end 654 and a spring 656 configured to bias protruding end 654 toward control ring 612 as shown, for example, in FIG. 31. In some embodiments, spring 656 can be coupled between lever 625 of handle body 610 and protruding end 654 such that protruding end 654 can be biased towards control ring 612.

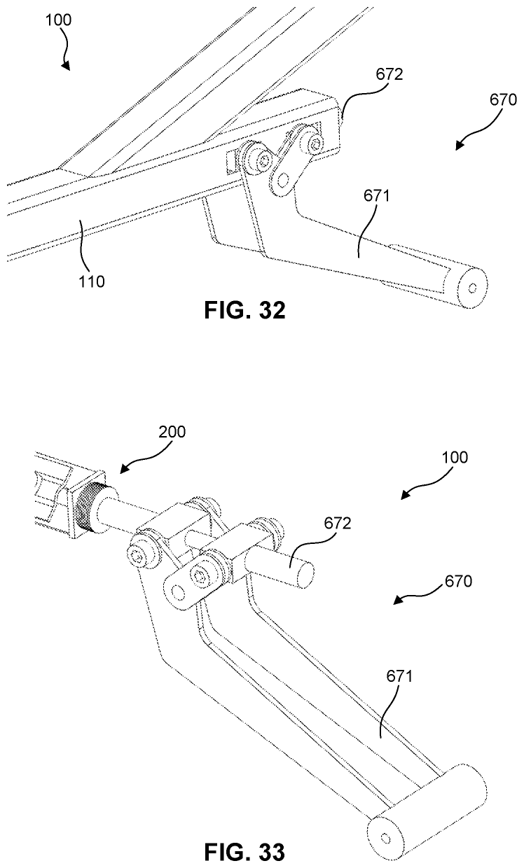

In some embodiments, load carrier 100 can include a handle assembly 670 that uses a linkage assembly to apply a desired torque to locking mechanism 200 as shown, for example, in FIGS. 32 and 33. In some embodiments, handle assembly 670 can be a knee-joint handle such that actuation of handle assembly 670 moves first actuator 210 in third direction 30 and second actuator 220 in fourth direction. In some embodiments, handle assembly 670 is coupled to connecting member 110 and includes a handle 671 that extends below connecting member 110 toward the ground. In some embodiments, handle 671 is pushed down to move locking mechanism into locked position 50. In some embodiments, handle 671 can extend above connecting member 110, away from the ground. In some embodiments, handle 671 is pulled up to move locking mechanism into locked position 50.

In some embodiments, handle assembly 670 can include fine adjusting bolt 672 as shown, for example, in FIGS. 32 and 33. Fine adjusting bolt 672 can adjust a torque load of handle assembly such that when handle 671 is actuated, a desired torque is applied to locking mechanism 200. In some embodiments, fine adjusting bolt 672 can be used for the first time load carrier 100 is attached to hitch receiver 14, to adjust for tolerance differences between different hitches 14. In some embodiments, after the initial attachment and setting of fine adjusting bolt 672, then the user only needs to actuate the handle 671 when securing load carrier 100 to hitch receiver 14.

In some embodiments, handle assembly 671 may be beneficial because it can shorten the time needed to secure the load carrier 100 to hitch receiver 14. In some embodiments, handle assembly 671 can also reduce the need to repeatedly lift or push the load carrier 100 slightly when tightening, which may be needed with existing load carriers when tightening with a threaded rod to ensure a good fit between connecting member 110 and hitch receiver 14.

It is to be appreciated that the Detailed Description section, and not the Brief Summary and Abstract sections, is intended to be used to interpret the claims. The Summary and Abstract sections may set forth one or more but not all exemplary embodiments of load carriers and locking mechanisms as contemplated by the inventors, and thus, are not intended to limit the present embodiments and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A hitch-mounted load carrier, comprising:
a connecting member configured to be inserted into a hitch receiver; and
a locking mechanism coupled to the connecting member and configured to secure the connecting member inside the hitch receiver, the locking mechanism comprising:
a first actuator disposed in an interior of the connecting member,
a second actuator opposite the first actuator and disposed in the interior of the connecting member,
a shaft configured to move at least one of the first actuator and the second actuator, and
a clamp assembly comprising a first contact member and a second contact member, wherein the first and second contact members are configured to engage an interior surface of the hitch receiver.

2. The hitch-mounted load carrier of claim 1, wherein a first surface of the clamp assembly contacts the first actuator and a second surface of the clamp assembly contacts the second actuator, and wherein the first and second actuators are configured to translate the clamp assembly.

3. The hitch-mounted load carrier of claim 2, wherein at least one of the first surface and the second surface comprises an arc-shape.

4. The hitch-mounted load carrier of claim 1, wherein the clamp assembly comprises a first clamp and a second clamp.

5. The hitch-mounted load carrier of claim 4, wherein the first clamp moves independently of the second clamp in a first direction.

6. The hitch-mounted load carrier of claim 4, wherein one of the first clamp or the second clamp comprises a protrusion, and the other of the first clamp and the second clamp comprises a recess configured to receive the protrusion.

7. The hitch-mounted load carrier of claim 6, wherein when the protrusion engages the recess, the first clamp and second clamp move together.

8. The hitch-mounted load carrier of claim 4, wherein the first clamp comprises a first side wall and the second clamp comprises a second side wall configured to engage the first side wall and transfer a load from the second clamp to the first clamp or receive a load from the first clamp.

9. The hitch-mounted load carrier of claim 1, wherein the clamp assembly further comprises a bridge connecting the first and second contact members.

10. The hitch-mounted load carrier of claim 1, wherein the locking mechanism is arranged between opposite corners of the connecting member.

11. The hitch-mounted load carrier of claim 1, wherein a first aperture and a second aperture are formed through the connecting member, and wherein the first contact member extends through the first aperture and the second contact member extends through the second aperture.

12. The hitch-mounted load carrier of claim 1, further comprising a spring coupled to the clamp assembly and contacting an interior surface of the connecting member, wherein the spring is configured to bias the clamp assembly away from the interior surface of the hitch receiver.

13. The hitch-mounted load carrier of claim 1, wherein the shaft comprises a first threaded portion and a second threaded portion.

14. The hitch-mounted load carrier of claim 13, wherein the first threaded portion is coupled to the first actuator and configured to move the first actuator in a first direction, and wherein the second threaded portion is coupled to the second actuator and configured to move the second actuator in a second direction opposite the first direction.

15. The hitch-mounted load carrier of claim 1, wherein the first actuator comprises a slot configured to receive the clamp assembly, and wherein the slot comprises a sloped surface configured to engage the clamp assembly.

16. A hitch-mounted load carrier, comprising:
a connecting member configured to be inserted into a hitch receiver; and
a locking mechanism coupled to the connecting member and configured to secure the connecting member inside the hitch receiver, the locking mechanism comprising:
a first actuator disposed in an interior of the connecting member,
a second actuator opposite the first actuator and disposed in the interior of the connecting member,
an actuator plate coupled to the first actuator and configured to move the first actuator,
a shaft configured to move at least one of the second actuator and the actuator plate, and
a clamp assembly moveably engaged with the first actuator and the second actuator, wherein the clamp assembly is configured to engage an interior surface of the hitch receiver.

17. The hitch-mounted load carrier of claim 16, wherein the actuator plate extends from the first actuator towards the shaft and overlaps a portion of the clamp assembly and a portion of the second actuator.

18. The hitch-mounted load carrier of claim 16, wherein the shaft is rotatably coupled to the second actuator and a fastener, wherein the fastener is coupled to the actuator plate, and wherein when the shaft is rotated, the second actuator moves in a first direction and the actuator plate moves in a second direction opposite the first direction.

19. The hitch-mounted load carrier of claim 16, wherein the actuator plate comprises a slot configured to receive a protrusion extending from the clamp assembly, and wherein the protrusion moves within the slot to control movement of the clamp assembly.

20. The hitch-mounted load carrier of claim 19, wherein the slot extends at an angle relative to a length direction of the shaft.
